(19) United States
(12) Patent Application Publication
(10) Pub. No.: US 2016/0283549 A1
(43) Pub. Date: Sep. 29, 2016

(54) VALUE SORTER

(71) Applicant: Intel Corporation, Santa Clara, CA (US)

(72) Inventor: William A. Hux, Hillsboro, OR (US)

(21) Appl. No.: 14/671,954

(22) Filed: Mar. 27, 2015

(51) Int. Cl. G06F 17/30

(52) U.S. Cl. CPC G06F 17/30424; G06F 17/30483

(57) ABSTRACT

Apparatuses, systems, and methods may sort a value. A sorter may include a data exchanger to exchange a value that is to be held by a first execution element of a plurality of execution elements with a value that is to be held by a second execution element of the plurality of execution elements. The sorter may also include a data comparator to compare a value that is to be held by the first execution element with the value from the second execution element and a value that is to be held by the second execution element with the value from the first execution element. The values involved in the exchange and the compare may remain locally sorted and globally shuffled in a final output of the sorter that is to be stored.

### BACKGROUND

Sorting may involve comparing and then exchanging pairs of values to sort the values into an order. For example, sorting may include comparing a pair of values and rearranging a lesser value of the pair and a greater value of the pair to provide an output of values in an order of lowest value to greatest value. Sorting, however, may require relatively large memory bandwidth or coordination. For example, each thread (in a thread block) and/or work-item (in a work-group) may execute two reads (e.g., load data from work-group shared local memory), a compare (e.g., per work-item) with swap if needed, and two writes from shared local memory (e.g., write data back to work-group shared local memory) with a synchronization across all threads and/or work-items cooperating in the sort (e.g., synchronize read/write access to shared local memory). Thus, conventional sorting may be limited by memory bandwidth, may result in relatively lower performance, and/or may result in relatively higher power requirements.

### BRIEF DESCRIPTION OF THE DRAWINGS

The various advantages of the embodiments of the present invention will become apparent to one skilled in the art by reading the following specification and appended claims, and by referencing the following drawings, in which:

FIGS. 1A-1C are a block diagrams of an example of a computing system to sort a value according to an embodiment;

FIG. 2 is a flowchart of an example of a method to sort a value according to an embodiment;

FIG. 3 is a graph of an example of performance by a sorter according to an embodiment;

FIGS. 4-6 are block diagrams of an example of an overview of a data processing system according to an embodiment;

FIG. 7 is a block diagram of an example of a graphics processing engine according to an embodiment;

FIGS. 8-10 are block diagrams of examples of execution units according to an embodiment;

FIG. 11 is a block diagram of an example of a graphics pipeline according to an embodiment;

FIGS. 12A-12B are block diagrams of examples of graphics pipeline programming according to an embodiment;

FIG. 13 is a block diagram of an example of a graphics software architecture according to an embodiment; and

FIGS. 14-15 are block diagrams of examples of core implementations according to an embodiment.

### DETAILED DESCRIPTION

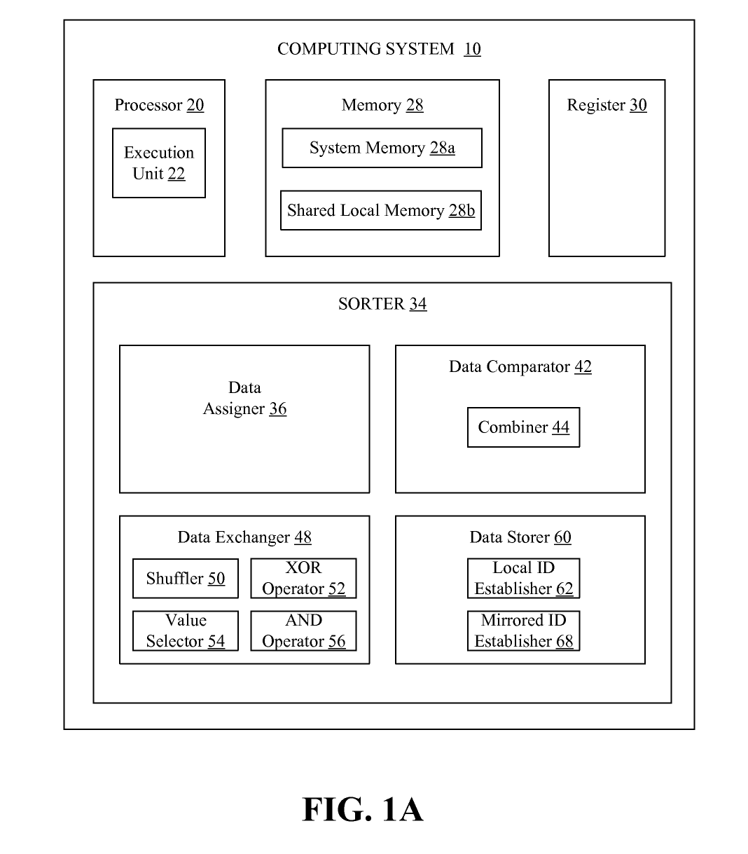

FIGS. 1A-1C show a computing system 10 to sort a value according to an embodiment. The computing system 10 may include, for example, a desktop computer, notebook computer, tablet computer, convertible tablet, personal digital assistant (PDA), mobile Internet device (MID), media player, smart phone, smart televisions (TVs), radios, game console, wearable computer, server, etc., or any combination thereof. As discussed below, the computing system 10 may locally sort a value according to a pattern of a sorting network 14 by implementing an exchange-then-compare 16 and/or may globally sort the value by implementing a scatter store 18. Notably, an exchange may be implemented first (to co-locate data) followed by a compare (to order the data locally), wherein the data is left shuffled before progressing to a next exchange-then-compare operation (e.g., phase, stage, etc.). Also, the locally sorted (e.g., at each work-item) but globally shuffled (e.g., work-item to work-item) data may be scattered out globally sorted to memory.

The computing system 10 includes a processor 20 having an execution unit 22, which may include one or more parallel processing lanes. For example, the execution unit 22 may include a core of a compute device, such as a graphics processor (e.g., GPGPU), with an n-wide (n=any power-of-two) single instruction multiple data (SIMD) architecture. Generally, the processor 20 may support a plurality of execution units (e.g., forty execution units), which in turn may each support a plurality of execution blocks (e.g., seven execution blocks) that each support a plurality of execution elements (EE) (e.g., eight EE, sixteen EE, thirty-two EE, etc.).

In the illustrated example, the computing system 10 includes an execution block 24 with a plurality of execution elements 26 (26a-26h) to accomplish work, such as sorting a set of values into an order. For example, eight execution elements 26a-26h may execute in parallel utilizing a corresponding parallel processing lane (SIMD8) of the execution unit 22 to sort values. The execution block 24 may utilize any power-of-two SIMD size such as sixteen parallel processing lanes (SIMD16) on which sixteen corresponding execution elements execute in parallel, thirty-two parallel processing lanes (SIMD32) on which thirty-two corresponding execution elements in parallel, and so on. In addition, the execution block 24 and/or the execution elements 26 may be provided by any parallel computing framework such as, for example, CUDA (CUDA®, NVIDIA Corporation), OpenCL (OpenCL®, Apple Inc.), DirectCompute (Microsoft Corporation), OpenACC (OpenACC®, NVIDIA Corporation), and so on.

In one example, the execution elements 26 include a plurality of threads when the execution block 24 includes a thread block or a portion thereof (e.g., a warp) in a CUDA framework. In another example, the execution elements 26 include a plurality of work-items when the execution block 24 includes a work-group or a portion thereof (e.g., a sub-group) in an OpenCL framework. The computing system 10 may include a compiler (e.g., just-in-time compiler) to generate and/or apply an instruction set in a hardware machine language, for execution by the processor 20. Thus, for example, a SIMD8 architecture may be utilized in an OpenCL framework by enqueuing work-groups corresponding to a desired SIMD size (e.g., eight) and setting compiler options to force compilation of the desired size.

The computing system 10 further includes memory 28, which may include memory that resides at a different physical level and/or access level of a memory hierarchy relative to other memory. For example, the memory 28 may include system memory 28a such as main memory, global memory, and so on. The memory 28 may also include shared local memory 28b that is a relatively lower-latency memory physically nearer to the processor 20 (e.g., an L1 cache) than system memory 28a. Thus, data (e.g., a value to sort) may be transferred from the system memory 28a to provide relatively faster access by the execution elements 26, and may be transferred back to the system memory 28a to store a result (e.g., a sorted value).

The computing system 10 further includes a data register 30 to hold data that may be involved in a variety of data sharing and/or transfer events without involving the shared local memory 28b. As discussed below, one or more built-ins (e.g., shuffle built-in_shfl( ) in OpenCL) may be used to cause the execution elements 26 (e.g., work-items) of the element block 24 (e.g., work-group) to share data (e.g., directly exchange data, etc.) in the data register 30 without requiring access to the shared local memory 28b.

The computing system 10 further includes a sorter 34 to sort a set of values (e.g., data elements such as integers) based on a pattern of a sorting network, such as the bitonic sorting network 14. Generally, each of the execution elements 26 may implement operations to sort a set of values, including:

//1) load 2 contiguous 8-wide vectors based on the local id
data = vload 16(local_id, pData);
//2) sort by doing exchange-then-compare of 8-wide vectors
Sort( );
//3) scatter the data into sorted order
offset mirror_bits(local_id);
vstore 16(data, offset, pData);

wherein the local_id may be a consecutive numerical identifier per execution element, starting at zero. In some embodiments, the sorter 34 may sort multiple, independent subsets of data elements within a larger set of data elements by adding a global offset into the set to the local_id. In this case, the operations may include offset=(global_id & (mask off lower bits))|mirror_bits(local_id) before the store operation (e.g., vstore).

As illustrated in FIG. 1B, the sorting network 14 includes a pattern having a plurality of stages 38 (38a-38d) with one or more phases 40 (40a-40j) of a sorting operation. For example, the sorting network 14 includes an initial stage S0 38a having one phase P0 40a, a subsequent stage S3 38d (e.g., a final stage) having four consecutive phases P0 40g, P1 40h, P2 40i, P3 40j, and so on. Thus, the initial stage S0 38a is a single-phase stage to compare values at (e.g., within) each of the execution elements 26, while the subsequent phase stage S3 38b is a multi-phase stage to compare values between the execution elements 26 at (e.g., within) the execution elements 26. In the illustrated example, the sorting network 14 includes a plurality of channels (e.g., inputs) to which the execution elements 26 may be mapped. Hexadecimal notation 0-f is used for sixteen channels for illustration.

The sorter 34 includes a data assigner 36 to assign a pair of values to each of the execution elements 26. In this regard, the assignment of values may map the sorting network 14 to the execution block 24 and/or to the SIMD architecture. Accordingly, each of the execution elements 26 may hold two values corresponding to two channels of the sorting network 14 (e.g., one value per channel, two channels per execution element). In one example, the data assigner 36 may assign two values to the execution element 26a corresponding to two channels of the sorting network 14 referred to in hexadecimal notation as (0, 1), two values to the execution element 26h corresponding to two channels of the sorting network 14 referred to in hexadecimal notation as (e, f), and so on. Thus, the sorter 34 may sort sixteen values in parallel in the example SIMD8 implementation. The channels of the sorting network 14 are ordered from left to right (from a lesser channel to a greater channel) for illustration.

In another example, the data assigner 36 may assign a pair of vectors, each including a set of values (e.g., eight values), to each of the execution elements 26. Accordingly, each of the execution elements 26 may hold two vectors corresponding to two channels of the sorting network 14 (e.g., one vector per channel, two channels per execution element), wherein the pair of vectors may be involved in the exchange-then-compare 16. For example, the execution block 24 may utilize sixteen parallel processing lanes (SIMD16) on which sixteen corresponding execution elements of a single element block execute in parallel to sort 256 values.

Thus, the computing system 10 may provide relatively dense computational work using, e.g., a single work-group having sixteen work-items by utilizing the data assigner 36 to instruct (e.g., vload) each of the exection elements 26 as follows:

// “gid” stands for global id, “lid” stands for local id.
// gid ranges from 0..total number of values
// lid ranges from 0..number of work items in the execution block
uint gid = get_global_id(0);
uint lid = get_sub_group_local_id( );
float8 a8, b8;
int s;
int8 s8;
// each work item loads 16 consecutive values
// work items 0..15 will work on a total of 256 consecutive values
float16 d = vload16(gid, in_pData);

wherein p_Data may be the base of the data to be sorted (e.g., pointer to the data) and vload16 with the global ID may allow each work-item having a local ID (e.g., 0-15) within a sub-group to load 16 consecutive values and work on 256 consecutive values in parallel.

Although embodiments may include exchanging and then comparing pairs of values (e.g., sort 16 values in a SIMD8 implementation) at each of the execution elements 26, vectors may be exchanged and sorted across all vector values at each of the execution elements 26. In this regard, the sorter 34 may include a data comparator 42 having a combiner 44 to merge a pair of vectors, each including a set of values, corresponding to two channels of the sorting network 14 at each of the execution elements 26. For example, a merge operation may combine two vectors that each include eight values to sort across sixteen values per each of the execution elements 26 rather than exchanging a pair of values.

Thus, for example, the combiner 44 may be utilized (e.g., Merge) to cause the execution elements 26 to merge the vectors to locally sort across all the values in each of the vectors in the initial stage S0 38a as follows:

//Start with step to sort 16 wide

d=Sort8(d);

d=Merge2x8(d.lo, d.hi);

wherein the execution elements 26 may each be used to implement a vector sort and a vector merge operation, e.g., to sort shorter vectors and merge two such sorted shorter vectors into a sorted wider vector of twice the length (e.g. sort 8-wide vector and merge two 8-wide vectors into a 16-wide vector). The merged, sorted, wide vectors may then be treated as two separate shorter, sorted vectors for subsequent operations.

The sorter 34 further includes a data exchanger 48 to exchange a value (e.g., a single value, a vector, etc.) that is held by a first execution element with a value that is held a second execution element. For example, the data exchanger 48 may be utilized (e.g., xor, select, etc.) to cause the execution element 26a to exchange a value held by the execution element 26a (e.g., corresponding to channel 0) with a value held by the execution element 26b (e.g., corresponding to channel 3) in the phase P0 40b. After the exchange is completed in the phase P0 40b, the execution element 26a effectively has channels (0, 3), the execution element 26b effectively has channels (1, 2), and so on.

The data exchanger 48 includes a shuffler 50 to directly exchange values between the execution elements 26 without an access to the shared local memory 28b. In one example, the shuffler 50 may be utilized (e.g., shuffle built-in such as_shfl( ) in OpenCL) to cause the execution elements 26 to share data (e.g., directly exchange data, etc.) without requiring access to the shared local memory 28b. Notably, at least two reads, two writes, and one synchronization per each of the execution elements 26 may be replaced with a single exchange event (e.g., no synchronization for memory accesses) for each of the execution elements 26 within the element block 24. Thus, a relative reduction to the memory bandwidth needed to sort may result in relatively better performance and/or relatively reduced power requirements.

The data comparator 42 may then compare values after the exchange is completed in the phase P0 40b. For example, the data comparator 42 may compare a value that is held by a first execution element with a value from a second execution element and in parallel a value that is held by the second execution element with a value from the first execution element. Thus, the data comparator 42 may compare a value held by the execution element 26a (e.g., corresponding to channel 0) with the value from the execution element 26b (e.g., corresponding to channel 3), and in parallel compare a value held by the execution element 26b (e.g., corresponding to channel 2) with the value from the execution element 26a (e.g., corresponding to channel 1). Notably, the combiner 44 may be utilized to cause (e.g., Merge) the execution element 26a to merge a vector held by the execution element 26a (e.g., corresponding to channel 0) with the vector from the execution element 26b (e.g., corresponding to channel 3) to locally sort across all of the values in each of the vectors, and so on for each of the execution elements 26b-26h.

The values involved in the exchange-then-compare 16 are allowed to remain locally sorted and globally shuffled when loaded in the sorting network 14. It this regard, it is unnecessary to send a value corresponding to a greater channel (e.g., channel 3) back to its source, such as the execution element 26b, before proceeding to a subsequent phase and/or a subsequent stage in a sorting network. In addition, it is unnecessary to maintain a bookkeeping structure to track a relationship between identifiers of the execution elements 26 and the values that are locally sorted. A data-to-execution element identifier (ID) relationship may become shuffled in a specific pattern, and final data may be scattered into order by computing an index based on an execution element ID. Thus, relatively better performance and/or reduced power requirements may be provided.

Accordingly, the data exchanger 48 further includes an XOR operator 52 to execute an XOR operation for each of the execution elements 26. The XOR operation may be between an execution element identifier ID (e.g., 0-7) of each of the execution elements 26 in a binary pattern such as 000=0, 001=1, 010=2, etc., and a number of the stage in the sorting network 14. In the illustrated example, the number of the stage may include 1-3 for S1 38b to S3 38d, respectively, which may be utilized to set a number of bits in a binary pattern for use in the XOR operation. For example, the number two of the stage S2 38c may be utilized to set two bits in a binary pattern such as 0011 for an XOR operation applying XOR 3.

In one example for the initial phase P0 40b of the multi-phase stage S1 38b, the XOR operator 52 may execute the XOR operation between the execution element identifier ID 0 and the number 1 (0 XOR 1), between the execution element identifier ID 1 and the number 1 (1 XOR 1), and so on for each of the execution elements 26. Each output of the XOR operation for each of the execution elements 26 may identify an exchange partner in the initial phase P0 40b. In addition, the data exchanger 48 further includes a value selector 54 to select a greater value (e.g., corresponding to a greater channel) of each exchange partner in the initial phase P0 40b for the exchange.

The XOR operator 52 may also execute a subsequent XOR operation for each of the execution elements 26 between the execution element ID of each of the execution elements 26 and a number beginning with the number one (e.g., the number one in a binary pattern such as 01, 0001, etc.) that doubles with each subsequent phase of the same stage, such as the subsequent phase P1 40c of the stage S1 38b. In one example, the XOR operator 52 may execute the subsequent XOR operation between the execution element identifier ID 0 and the number 1 (0 XOR 1), between the execution element identifier ID 1 and the number 1 (1 XOR 1), and so on for each of the execution elements 26. Each output of the subsequent XOR operation for each of the execution elements 26 may identify an exchange partner for each of the execution elements 26 in the subsequent phase P1 40c.

The data exchanger 48 may also include an AND operator 56 to execute an AND operation for each of the execution elements 26 between each output of the subsequent XOR operation and the number beginning with the number one that doubles with each subsequent phase in the same stage, such as the subsequent phase P1 40c of the stage S1 38b. Each output of the AND operation may identify a value and/or a channel to be involved in the exchange in the subsequent phase in the same stage, such as the phase P1 40c. In addition, the value selector 54 may select a greater value (e.g., corresponding to a greater channel) when an output of the AND operation is zero and exchange a lesser value (e.g., corresponds to a lesser channel) when the output of the AND operation is one.

Thus, for example, the XOR operator 52 may be utilized (e.g., xor) to cause the execution elements 26 to determine exchange partners, the AND operator 56 may be utilized (e.g., &) to cause the execution elements 26 to determine values to exchange, and/or the value selector 54 may be utilized (e.g., select) to cause the execution elements 26 to select values to exchange in the stage S1 38b and the stage S2 38c as follows:

//-----------------------------------------------------
// 1st stage
//-----------------------------------------------------
// 0:3, 2:1, 4:7, 6:5, 8:b, a:9
b8 = intel_sub_group_shuffle_xor(d.hi, 1);
d = Merge2×8(d.lo, b8);
// 0:1, 2:3, ...
s = lid & 1;
s8 = −s; // negation as required by OpenCL
a8 = select(d.hi, d.lo, s8);
b8 = select(d.lo, d.hi, s8);
a8 = intel_sub_group_shuffle_xor(a8, 1);
d = Merge2×8(a8, b8);
//-----------------------------------------------------
// 2nd stage
//-----------------------------------------------------
// 0:7, 2:5, 4:3, 6:1, 8:f, ...
b8 = intel_sub_group_shuffle_xor(d.hi, 3);
d = Merge2×8(d.lo, b8);
// 0:2, 5:7, 1:3, 4:6
s = lid & 1;
s8 = −s; // negation as required by OpenCL
a8 = select(d.hi, d.lo, s8);
b8 = select(d.lo, d.hi, s8);
a8 = intel_sub_group_shuffle_xor(a8, 1);
d = Merge2×8(a8, b8);
// 0:1 4:5 2:3 6:7 8:9 c:d a:b e:f, ...
s = lid & 2;
s8 = −s; // negation as required by OpenCL
a8 = select(d.hi, d.lo, s8);
b8 = select(d.lo, d.hi, s8);
a8 = intel_sub_group_shuffle_xor(a8, 2);
d = Merge2×8(a8, b8);

wherein the instruction “intel_sub_group_shuffle_xor” may be executed to perform an exchange with XOR on local id. The “Merge” instruction may be executed to perform a swap, wherein eight values may be exchanged at a time and sorted across 16 values rather than swapping two values. In addition the “select” instructions may be executed to choose a “greater” or a “lesser” value to be exchanged. The instruction select( ) may include a standard OpenCL instruction, the instruction shuffle( ) may include an extension to OpenCL, and the instruction Merge2x8( ) may include an instruction (e.g., function) to implement a portion of a sixteen-wide network sort.

For the purpose of illustration, FIG. 1B may include assigning a pair of vectors to each the execution elements 26 (e.g., work-items) in a SIMD8 architecture. For example, each of the execution elements 26 may load two vectors in the stage S0 38a, which is the only single-phase stage of the sorting network 14 and which has a stage number of zero. Each of the execution elements 26 merge two vectors and swap values to locally sort the value across the vectors if necessary. For example, the execution element 26a compares values in two vectors (e.g., corresponding to channels 0:1), the execution element 26b compares values in two vectors (e.g., corresponding to channels 2:3), etc., and swaps the values to sort the values across the two vectors if the values are not in order. After the compare in phase P0 40a, the execution element 26a has channels (0, 1), the execution element 26b has channels (2, 3), and so on.

At the stage S1 38b, which is an initial multi-phase stage of the sorting network 14 and which has a stage number of one, an exchange partner may be determined by each of the execution elements 26 in the phase P0 40b. For example, each of the execution elements 26 may compute: exchange with execution element (e.g., work item)=local id XOR 1. A number of bits for use in the XOR operation may be set equal to a number of a stage, such that the number one of the stage S1 38b is utilized to set one bit in a binary pattern (e.g., 01) to implement the XOR operation (e.g., XOR 1).

In one example, 1 XOR 1 is 0, 0 XOR 1 is 1. The execution element 26a having the execution element ID 0 and the execution element 26b having the execution element ID 1 will exchange with each other, and so on (e.g., EE0 with EE1, EE2 with EE3, EE4 with EE5, EE6 with EE7). Each of the execution elements 26 may exchange the greater values (e.g., corresponding to their respective greater channels) in the phase P0 40b. For example, the execution element 26a will exchange with the execution element 26b the greater value (e.g., corresponding to the greater channel 1) and the execution element 26b will exchange with the execution element 26a the greater value (e.g., corresponding to the greater channel 3), and so on. Thus, the execution element 26a will effectively have channels (0, 3) and the execution element 26b will effectively have the channels (1, 2). The channel pattern may therefore become, in the phase P0 40b, 0:3, 2:1, 4:7, 6:5, 8:b, a:9, etc.

In addition, an exchange partner may be determined in the subsequent phase P1 40c by each of the execution elements 26, and a determination may be made by each of the execution elements 26 regarding which of the two values (e.g., lesser value of the lesser channel or greater value of the greater channel) to exchange. Each of the execution elements 26 may compute: exchange with local id XOR 1; AND local id with 1, if 0, exchange the greater value of the greater channel, if 1, exchange the lesser value of the lesser channel. The subsequent XOR operation for each of the execution elements 26 may be between the execution element ID and a number beginning with the number one that doubles with each subsequent phase of a multi-phase stage, such that a number one in a binary pattern (e.g., 01) may be used to implement the subsequent XOR operation (e.g., XOR 1) in the phase P1 40c. In one example, 1 XOR 1 is 0, 0 XOR 1 is 1. Thus, the execution element 26a having the execution element ID 0 and the execution element 26b having the execution element ID 1 will exchange with each other.

In addition, 0 AND 1 is 0, 1 AND 1 is 1. The AND operation for each of the execution elements 26 may be between the execution element ID and the number beginning with the number one that doubles with each subsequent phase of the multi-phase stage, such that the number one in a binary pattern (e.g., 01) may be used to implement the AND operation (e.g., AND 1). The execution element 26a having the execution element ID 0 will exchange the greater value (e.g., corresponding to the greater channel 3) based on the result of the AND operation (e.g., 0) and the execution element 26b having the execution element ID 1 will exchange the lesser value (e.g., corresponding to the lesser channel 1) based on the result of the AND operation (e.g., 1). The channel pattern may therefore become, in the phase P1 40c, 0:1, 2:3, 4:5, etc.

The exchange of values, followed by the compare of values and swapping of values (if necessary) is repeated according to the same exchange pattern at each of the stages S2 38c, S3 38d. For example, at the stage S2 38c with a stage number of two, each of the execution elements 26 may compute: exchange with execution element (e.g., work item)=local id XOR 3 in the phase P0 40d. A number of bits for use in the XOR operation may be set equal to a number of a stage, such that the number two of the stage S2 38c is utilized to set two bits in a binary pattern (e.g., 0011) to implement the XOR operation (e.g., XOR 3). As illustrated in Table 1, the execution element 26a having the execution element ID 0 computes that it is to exchange with the execution element 26c having the execution element ID 3, and vice versa.

| EE (E.g., Work-item) | XOR 3 (0011) |
|---|---|
| 0 = 0000 | 0011 = 3 |
| 1 = 0001 | 0010 = 2 |
| 2 = 0010 | 0001 = 1 |
| 3 = 0011 | 0000 = 0 |
| 4 = 0100 | 0111 = 7 |
| 5 = 0101 | 0110 = 6 |
| 6 = 0110 | 0101 = 5 |
| 7 = 0111 | 0100 = 4 |

In one example, 0 XOR 3 is 3, 3 XOR 3 is 0. The execution element 26a having the execution element ID 0 and the execution element 26c having the execution element ID 3 will exchange with each other, and so on (e.g., EE0 with EE3, EE1 with EE2, EE4 with EE7, EE5 with EE6). Each of the execution elements 26 may exchange the greater values (e.g., corresponding to their respective greater channels) in the phase P0 40d. For example, the execution element 26a will exchange with the execution element 26c the greater value (e.g., corresponding to the greater channel 1) and the execution element 26c with exchange with the execution element 26a the greater value (e.g., corresponding to the greater channel 7), and so on. Thus, the execution element 26a will effectively have channels (0, 7) and the execution element 26d will effectively have the channels (1, 6). The channel pattern may therefore become, in the phase P0 40d, 0:7, 2:5, 4:3, 6:1, 8:f, etc.

In addition, an exchange partner may be determined in the subsequent phase P1 40e by each of the execution elements 26, and a determination may be made by each of the execution elements 26 regarding which of the two values (e.g., lesser value of the lesser channel or greater value of the greater channel) to exchange. Each of the execution elements 26 may compute: exchange with local id XOR 1; AND local id with 1, if 0, exchange the greater value of the greater channel, if 1, exchange the lesser value of the lesser channel; exchange with local id XOR 2; AND local id with 2, if 0, exchange the greater value of the greater channel, if 1, exchange the lesser value of the lesser channel.

The subsequent XOR operation for each of the execution elements 26 may be between the execution element ID and a number beginning with the number one that doubles with each subsequent phase of a multi-phase stage, such that a number one in a binary pattern (e.g., 0001) may be used to implement the subsequent XOR operation (e.g., XOR 1) in the phase P1 40e. For example, the execution element 26a having the execution element ID 0 and the execution element 26b having the execution element ID 1 will exchange with each other, and so on (e.g., EE0 with E1, EE2 with EE3, EE4 with EE5, EE6 with EE7) in the phase P1 40e.

Similarly, a number two (doubling of the number one) in a binary pattern (e.g., 0010) may be used to implement the subsequent XOR operation (e.g., XOR 2) in the phase P2 40f. The execution element 26a having the execution element ID 0 and the execution element 26c having the execution element ID 2 will exchange with each other, and so on (e.g., EE0 with EE2, EE1 with EE3, EE4 with EE6, EE5 with EE7) in the phase P2 40f. Thus, the number to be used in each subsequent XOR operation that follows an initial XOR operation is to begin with the number one for a first subsequent phase and is to double with each consecutive subsequent phase in the same stage.

In addition, the AND operation for each of the execution elements 26 may be between the execution element ID and the number beginning with the number one that doubles with each subsequent phase of a multi-phase stage, such that the number one in a binary pattern (e.g., 0001) may be used to implement the AND operation (e.g., AND 1) in the phase P1 40e and such that the number two in a binary pattern (e.g., 0010) may be used to implement the AND operation (e.g., AND 2) in the phase P2 40f. Thus, the number to be used in each AND operation is to begin with the number one for a first subsequent phase and is to double with each consecutive subsequent phase in the same stage.

Additionally, each output of the AND operation may identify a value and/or a channel to be involved in the exchange in the subsequent phase. For example, each output of the AND operation in the phase P1 40e may identify a value and/or a channel to be involved in the exchange in the phase P1 40e, wherein the channel pattern may become 0:2, 5:7, 1:3, etc. In addition, each output of the AND operation in the phase P2 40f may identify a value and/or a channel to be involved in the exchange in the phase P2 40f, wherein the channel pattern may become 0:1, 4:5, 2:3, and so on.

The exchange pattern is scalable to any number of stages. As discussed above, the exchange pattern may include XOR 1, XOR 1, AND 1 for the stage S1 38b, and XOR 3, XOR 1, AND 1, XOR 2, AND 2 for the stage S2 38c. A further example includes XOR 7, XOR 1, AND 1, XOR 2, AND 2, XOR 4, AND 4 for the stage S3 38d (e.g., a first broad phase followed by a number of intermediate phases that equals the number of the stage, with a doubling of the XOR and the AND operators with increasing phase number within the stage). Additional examples include XOR 0xF, XOR 1, AND 1, XOR 2, AND 2, XOR 4, AND 4, XOR 8, AND 8 for a fifth stage, XOR 0x1F, XOR 1, AND 1, XOR 2, AND 2, XOR 4, AND 4, XOR 8, AND 8, XOR x10, AND x10 for a sixth stage, and so on. Notably, the XOR operation and the AND operation in any subsequent phase (e.g., after a broad phase of a stage) may execute in any order. Thus, for example, the exchange pattern may include XOR 1, AND 1, XOR 1 for the stage S1 38b, XOR 3, AND 1, XOR 1, AND 2, XOR 2 for the stage S2 38c, and so on.

Also, the values involved in the exchange-then-compare 16 remain locally sorted and globally shuffled at least between two or more phases of the sorting network 14 and/or at a final output 58 of the sorting network 14 and/or the sorter 34. For example, the execution element 26a effectively has the channels (0, 1) and the execution element 26b effectively has the channels (8, 9) at the final output 58. Thus, the values of the final output 58 are locally sorted at each of the execution elements 26 but are globally shuffled between the execution elements 26.

The sorter 34 includes a data storer 60 to store the values in the final output 58 to the memory 28 in a globally sorted order via the scatter store 18. For example, the data storer 60 may scatter the values in the output 58 to the memory 28 in sorted order by determining a local ID of each of the execution elements 26 and generating a scatter index that is a mirror of the bit pattern of each local ID of the execution elements 26. The number of bits of a local ID may be a function (log base 2) of a number of execution elements involved in a sort. For example, if there are 16 execution elements, the local ID may include 4 bits. In addition, the local ID may be a consecutive numerical number starting with zero for each execution block, such that 0 in binary may be 0000 for 16 execution elements, may be 000 for eight execution elements, and so on.

In the illustrated example, the data storer 60 includes a local ID establisher 62 to determine a local ID 64 for each execution element ID of each of the execution elements 26. As illustrated in FIG. 1C, the local ID establisher 62 may determine a binary pattern for each execution element ID to determine each local ID 64. For example, the local ID establisher 62 may make a determination 66 that the ID 0 of the execution element 26a is a binary pattern 000 when there are eight execution elements, that the ID 1 of the execution element 26b is a binary pattern 001 when there are eight execution elements, and so on.

In the illustrated example, the data storer 60 further includes a mirrored ID establisher 68 to determine a mirrored ID 70 for each local ID 64. As illustrated in FIG. 1C, the mirrored ID establisher 68 may determine a mirrored binary pattern for each local ID 64 to determine each mirrored ID 70. For example, mirrored ID establisher 68 may make a determination 72 that the mirror of the local ID 000 is a binary pattern 000, that the mirror of the local ID 001 is a binary pattern 100, and so on.

In one example, a most significant bit may be swapped with a least significant bit (far left bit is shifted right to the far right, while far right bit is shifted to the far left), the next most significant bit may be swapped with the next-least significant bit, and so on. This pattern may be applied generally for any number of bits (e.g., number of bits may not necessarily be a power-of-two, or even). Thus, in one example SIMD16 implementation, the mirrored ID establisher 68 may be utilized to determine the mirrored ID from the local ID as follows:

uint offset=((local_id & 8))>>3|((local_id & 4)>>1)|((local_id & 2)<<1|((local_id & 1)<<3);

vstore16 (data, offset, in_pData); //stores 16 values wherein the far left bit is shifted to the far right (e.g., >>3) and the far right bit is shifted to the far left (e.g., <<3), and so on, and wherein 16 values are stored at a location in memory (e.g., in p_Data) for each of the execution elements 26 using the mirrored bits.

The data storer 60 may store the values of the output 58 based on the mirrored ID 70. For example, the data storer 60 may scatter 72 the values of the output 58 to a corresponding location in the memory 28 based on each mirrored ID 70. As illustrated in FIG. 1C, the data storer 60 may store the values of the output 58 corresponding to the channels (0, 1), effectively of the execution element 26a, to a corresponding first location in the memory 28 based on the mirrored binary pattern 000. The data stoner 60 may store the final values of the output 58 corresponding to the channels channels (8, 9), effectively of the execution element 26b, to a corresponding fourth location in the memory 28 based in the mirrored binary pattern 100, and so on. Thus, the data storer 60 may implement the scatter 72 to sort the values of the output 58 in a globally sorted order 74.

In one embodiment when the sorter 34 is sorting a subset of data elements within a larger pool of data elements, the local ID may be added to a global offset into the larger set. For example, a global ID of a work-item may be different than a local ID of the work-item within a larger pool of data elements, such as when the local ID is 0-255 and the global ID is 512-767 for a larger pool of one million data elements. Accordingly, the local ID may be added to the global offset (e.g., 2 added to 512 for local ID 2 and global ID 514) to sort multiple, independent subsets of data elements within the larger set of data elements. Similarly, the local ID may be added to a global offset into the larger set before the store operation to store corresponding data elements to a correct storage location via an instruction such as offset=(global)id & (˜0x0F))|offset (e.g., before vstore16 (data, offset, in_pData)). Generally, the mirror may only need to be applied to the local ID, wherein the global ID and/or the offset do not participate in the mirror and are to be masked off.

The sorter 34 is extensible to any power-of-two sort. For example, the sorter 34 may halt after completion of the stage S1 38b of the sorting network 14 to obtain sets of eight values fully sorted by applying a mirrored binary pattern for four of the execution elements 26a-26d. In this regard, determining the local ID and the mirrored ID may utilize 2 bits (log base 2 of 4=2). Example Table 2 shows that a sort may be obtained by writing values in an order specified by a mirror of the local ID bits rather than straight local ID order.

| Local ID | Local ID | Mirrored ID (Mirrored Bits | Re-Ordering using |
|---|---|---|---|
| (Channels) | (Bits) | of Local ID Bits) | Mirrored Bits |
| 0:1 | 00 | 00 | 0:1 |
| 4:5 | 01 | 10 | 2:3 |
| 2:3 | 10 | 01 | 4:5 |
| 6:7 | 11 | 11 | 6:7 |

To sort across eight of the execution elements 26a-26h, complete the stage S2 38c and mirror utilizing three bits. To sort across sixteen execution elements, complete the stage S3 38d and mirror utilizing four bits. To sort across thirty-two execution elements, add a fifth stage to the sorting network 14 and mirror utilizing five bits. The process may, therefore, be repeated for any power-of-two sort.

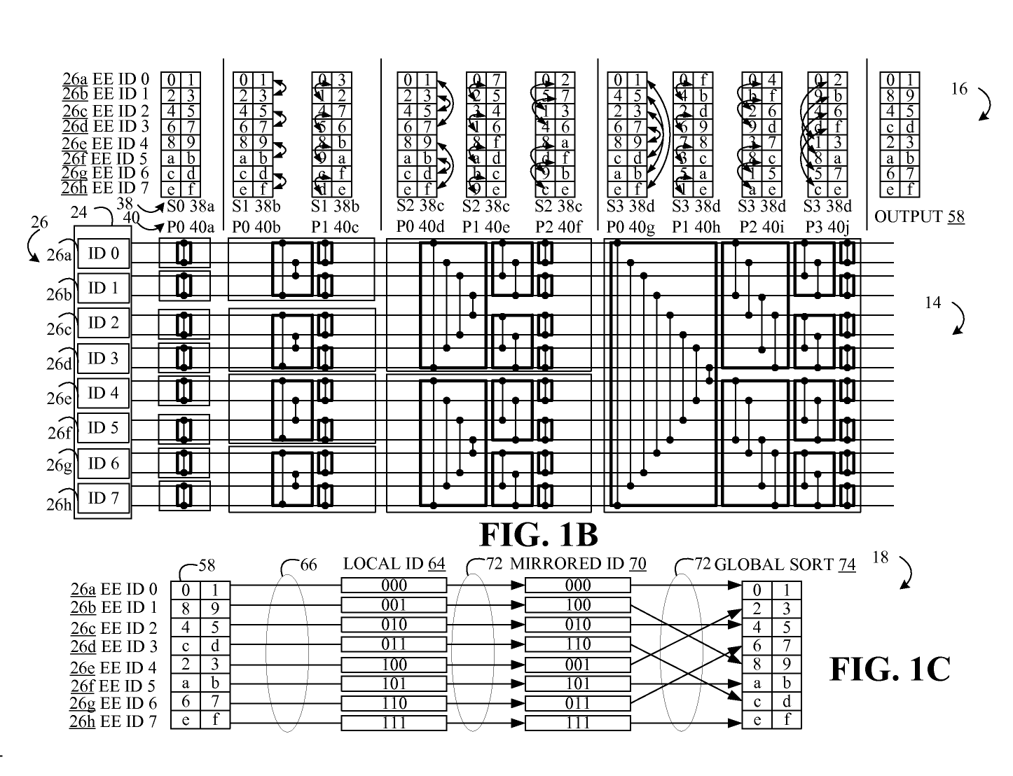

Turning now to FIG. 2, a method 76 to sort a value is shown according to an embodiment. The method 76 may be implemented as a set of logic instructions stored in a machine- or computer-readable storage medium such as random access memory (RAM), read only memory (ROM), programmable ROM (PROM), flash memory, etc., in configurable logic such as programmable logic arrays (PLAs), field programmable gate arrays (FPGAs), complex programmable logic devices (CPLDs), in fixed-functionality logic hardware using circuit technology such as application specific integrated circuit (ASIC), CMOS or transistor-transistor logic (TTL) technology, or any combination thereof. For example, computer program code to carry out operations shown in the method 76 may be written in any combination of one or more programming languages, including an object oriented programming language such as C++ or the like and conventional procedural programming languages, such as the “C” programming language or similar programming languages. Moreover, the method 76 may be implemented using any of the herein mentioned circuit technologies.

The illustrated processing block 77 provides for assigning a value to each of a plurality of execution elements. Each value may correspond to a channel of a sorting network, such as a bitonic sorting network. In one example, the processing block 77 may assign a pair of vectors, each including a set of values, to each of the execution elements, wherein the pair of vectors may be involved in exchanging, comparing, and/or storing.

The illustrated processing block 78 provides for exchanging a value. For example, the processing block 78 may exchange a value (e.g., corresponding to a channel of the sorting network) that is held by a first execution element of the plurality of execution elements with a value (e.g., corresponding to a channel of the sorting network) that is held by a second execution element of the plurality of execution elements. The illustrated processing block 79 provides for directly exchanging the value from the first execution element with the value from second execution element without an access to memory, such as shared local memory. In one example, the processing block 79 may utilize a shuffle built-in to directly exchange values.

The illustrated processing block 80 provides for executing an XOR operation for each of the execution elements based on an execution element ID of each of the execution elements. For example, the processing block 80 may execute an XOR operation between an execution element ID of each of the execution elements and a number of a stage in a sorting network. In one example, the processing block 80 may execute an initial XOR operation for an initial phase of a multi-phase stage of a sorting network between an execution element ID of each of the execution elements and a number of the multi-phase stage, wherein each output of the XOR operation is to identify an exchange partner for each of the execution elements in the initial phase.

In another example, the processing block 80 may execute a subsequent XOR operation for each subsequent phase of a multi-phase stage of a sorting network between an execution element ID of each of the execution elements and a number beginning with the number one that doubles with each subsequent phase of the multi-phase stage. Each output of the subsequent XOR operation may identify an exchange partner for each of the execution elements in the subsequent phase.

The illustrated processing block 81 provides for executing an AND operation for each of the execution elements between each output of the subsequent XOR operation and the number beginning with the number one that doubles. Each output of the AND operation may identify one or more of a value and a channel involved in the exchange in the subsequent phase. The illustrated processing block 82 provides for selecting a value. In one example, the processing block 82 may select a greater value (e.g., a greater vector including greater values) of each exchange partner in the initial phase for the exchange. In another example, the selector may select a greater value (e.g., a greater vector including greater values) when an output of the AND operation is zero and select a lesser value (e.g., a lesser vector including lesser values) when the output of the AND operation is one.

Illustrated processing block 83 provides for comparing a value. For example, the processing block 83 may compare a value that is held by the first execution element with the value from the second execution element and a value that is held by the second execution element with the value from the first execution element. Illustrated processing block 84 provides for merging two vectors, each including a set of values, at each of the execution elements to sort the set of values of each of the vectors into a locally sorted order.

Illustrated processing block 85 provides for storing values that are locally sorted and globally shuffled in a final output to memory in a globally sorted order. Illustrated processing block 86 provides for determining a local ID for each execution element ID of each of the execution elements. For example, the processing block 86 may determine a binary pattern for each execution element ID to determine each local ID. Illustrated processing block 87 provides for determining a mirrored ID for each local ID. For example, the processing block 87 may determine a mirrored binary pattern for each local ID to determine each mirrored ID. Illustrated processing block 88 provides for storing the values in the final output based on each mirrored ID. For example, the processing block 88 may scatter the values in the final output to a corresponding location in the memory based on each mirrored.

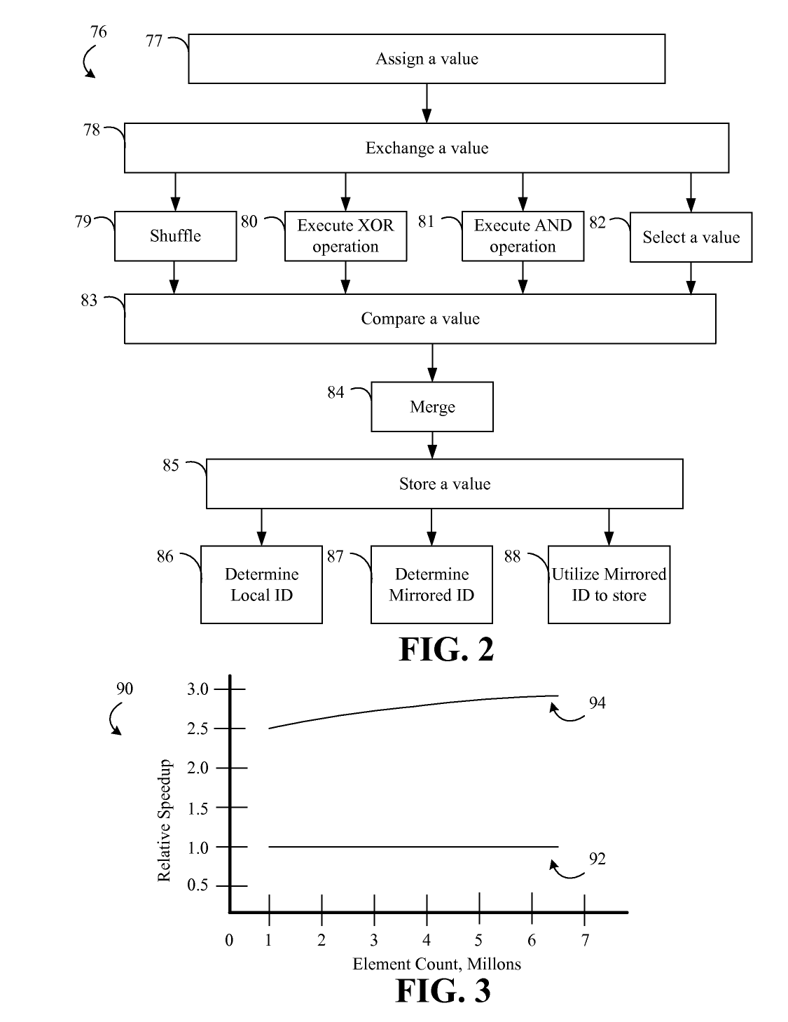

FIG. 3 illustrates a graph 90 of an example of a performance by a sorter according to an embodiment. In the illustrated example, a plot 92 of a conventional bitonic sorter is shown which performs synchronization across all execution elements in an execution block that cooperate in a sort. For example, each of the work-items repeatedly load data (e.g., two reads) from shared local memory, perform a comparison, and write data back (e.g., two writes) to the shared local memory with a synchronization to negotiate access to the shared local memory. Thus, multiple execution blocks (e.g., multiple work-groups) are required to collaborate to sort a relatively small number of elements (e.g., pairs of elements are loaded by each work-item), many synchronization operations are required, and a relatively large amount of shared local memory is utilized to perform exchanges.

A plot 94 for a sorter according to an embodiment shows an increase in performance greater than about 2.8 times. In the illustrated example, the sorter may utilize an exchange-then-compare to reduce memory transfers at least by about half. In addition, the sorter may utilize shuffle built-ins to eliminate synchronization. Moreover, the sorter may utilize a scatter to store the data as a final step. Further, the sorter may exchange and merge vectors that minimizes memory bandwidth relative to compute.

Notably, each execution element (e.g., work-item) in a SIMD16 implementation may simultaneously operate on 256 elements (e.g., 16 values per execution element) using relatively less stages compared to conventional bitonic sorting networks. Moreover, the SIMD16 implementation may provide a relatively dense computational work relative to global (e.g., DRAM) memory accesses. Also, the stages may be performed in parallel with no branches, loops, or synchronization by utilizing hardware cmp and select instructions that map to OpenCL-C built-in functions such as isless( ) and select ( ).

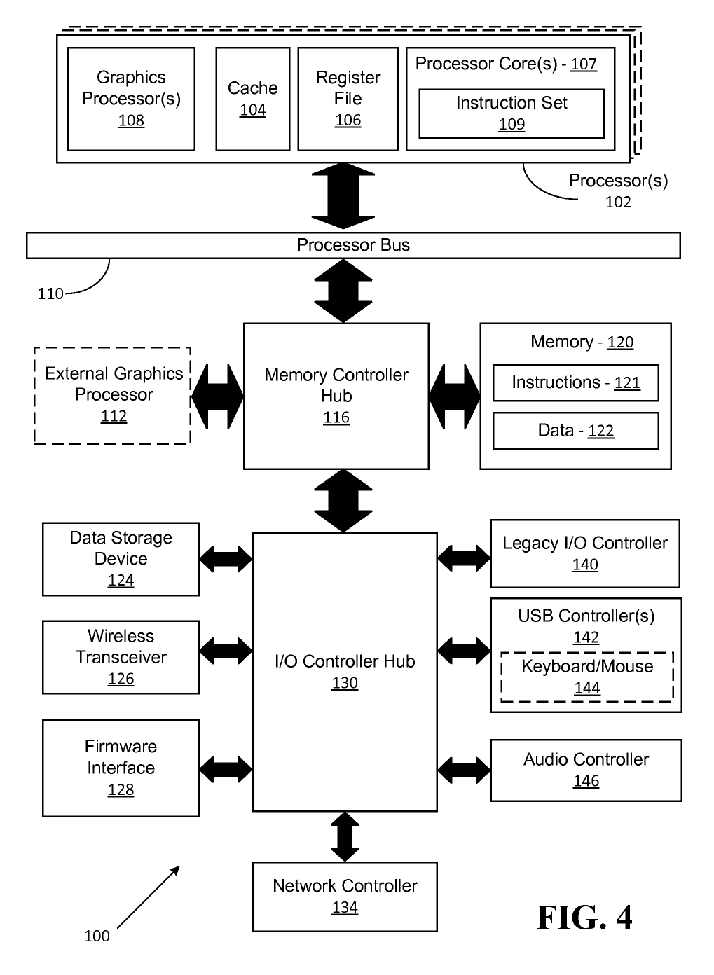

System Overview—FIGS. 4-6

FIG. 4 is a block diagram of a processing system 100, according to an embodiment. In various embodiments the system 100 includes one or more processors 102 and one or more graphics processors 108, and may be a single processor desktop system, a multiprocessor workstation system, or a server system having a large number of processors 102 or processor cores 107. In on embodiment, the system 100 is a processing platform incorporated within a system-on-a-chip (SoC) integrated circuit for use in mobile, handheld, or embedded devices.

An embodiment of system 100 can include, or be incorporated within a server-based gaming platform, a game console, including a game and media console, a mobile gaming console, a handheld game console, or an online game console. In some embodiments system 100 is a mobile phone, smart phone, tablet computing device or mobile Internet device. Data processing system 100 can also include, couple with, or be integrated within a wearable device, such as a smart watch wearable device, smart eyewear device, augmented reality device, or virtual reality device. In some embodiments, data processing system 100 is a television or set top box device having one or more processors 102 and a graphical interface generated by one or more graphics processors 108.

In some embodiments, the one or more processors 102 each include one or more processor cores 107 to process instructions which, when executed, perform operations for system and user software. In some embodiments, each of the one or more processor cores 107 is configured to process a specific instruction set 109. In some embodiments, instruction set 109 may facilitate Complex Instruction Set Computing (CISC), Reduced Instruction Set Computing (RISC), or computing via a Very Long Instruction Word (VLIW). Multiple processor cores 107 may each process a different instruction set 109, which may include instructions to facilitate the emulation of other instruction sets. Processor core 107 may also include other processing devices, such a Digital Signal Processor (DSP).

In some embodiments, the processor 102 includes cache memory 104. Depending on the architecture, the processor 102 can have a single internal cache or multiple levels of internal cache. In some embodiments, the cache memory is shared among various components of the processor 102. In some embodiments, the processor 102 also uses an external cache (e.g., a Level-3 (L3) cache or Last Level Cache (LLC)) (not shown), which may be shared among processor cores 107 using known cache coherency techniques. A register file 106 is additionally included in processor 102 which may include different types of registers for storing different types of data (e.g., integer registers, floating point registers, status registers, and an instruction pointer register). Some registers may be general-purpose registers, while other registers may be specific to the design of the processor 102.

In some embodiments, processor 102 is coupled to a processor bus 110 to transmit communication signals such as address, data, or control signals between processor 102 and other components in system 100. In one embodiment the system 100 uses an exemplary ‘hub’ system architecture, including a memory controller hub 116 and an Input Output (I/O) controller hub 130. A memory controller hub 116 facilitates communication between a memory device and other components of system 100, while an I/O Controller Hub (ICH) 130 provides connections to I/O devices via a local I/O bus. In one embodiment, the logic of the memory controller hub 116 is integrated within the processor.

Memory device 120 can be a dynamic random access memory (DRAM) device, a static random access memory (SRAM) device, flash memory device, phase-change memory device, or some other memory device having suitable performance to serve as process memory. In one embodiment the memory device 120 can operate as system memory for the system 100, to store data 122 and instructions 121 for use when the one or more processors 102 executes an application or process. Memory controller hub 116 also couples with an optional external graphics processor 112, which may communicate with the one or more graphics processors 108 in processors 102 to perform graphics and media operations.

In some embodiments, ICH 130 enables peripherals to connect to memory device 120 and processor 102 via a high-speed I/O bus. The I/O peripherals include, but are not limited to, an audio controller 146, a firmware interface 128, a wireless transceiver 126 (e.g., Wi-Fi, Bluetooth), a data storage device 124 (e.g., hard disk drive, flash memory, etc.), and a legacy I/O controller 140 for coupling legacy (e.g., Personal System 2 (PS/2)) devices to the system. One or more Universal Serial Bus (USB) controllers 142 connect input devices, such as keyboard and mouse 144 combinations. A network controller 134 may also couple to ICH 130. In some embodiments, a high-performance network controller (not shown) couples to processor bus 110. It will be appreciated that the system 100 shown is exemplary and not limiting, as other types of data processing systems that are differently configured may also be used. For example, the I/O controller hub 130 may be integrated within the one or more processor 102, or the memory controller hub 116 and I/O controller hub 130 may be integrated into a discreet external graphics processor, such as the external graphics processor 112.

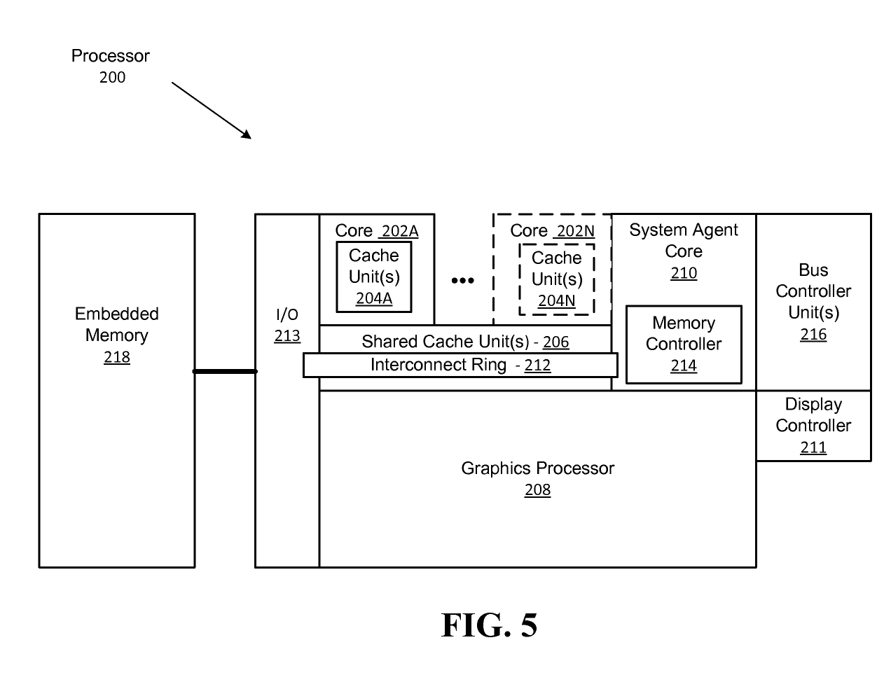

FIG. 5 is a block diagram of an embodiment of a processor 200 having one or more processor cores 202A-202N, an integrated memory controller 214, and an integrated graphics processor 208. Those elements of FIG. 5 having the same reference numbers (or names) as the elements of any other figure herein can operate or function in any manner similar to that described elsewhere herein, but are not limited to such. Processor 200 can include additional cores up to and including additional core 202N represented by the dashed lined boxes. Each of processor cores 202A-202N includes one or more internal cache units 204A-204N. In some embodiments each processor core also has access to one or more shared cached units 206.

The internal cache units 204A-204N and shared cache units 206 represent a cache memory hierarchy within the processor 200. The cache memory hierarchy may include at least one level of instruction and data cache within each processor core and one or more levels of shared mid-level cache, such as a Level 2 (L2), Level 3 (L3), Level 4 (L4), or other levels of cache, where the highest level of cache before external memory is classified as the LLC. In some embodiments, cache coherency logic maintains coherency between the various cache units 206 and 204A-204N.

In some embodiments, processor 200 may also include a set of one or more bus controller units 216 and a system agent core 210. The one or more bus controller units 216 manage a set of peripheral buses, such as one or more Peripheral Component Interconnect buses (e.g., PCI, PCI Express). System agent core 210 provides management functionality for the various processor components. In some embodiments, system agent core 210 includes one or more integrated memory controllers 214 to manage access to various external memory devices (not shown).

In some embodiments, one or more of the processor cores 202A-202N include support for simultaneous multi-threading. In such embodiment, the system agent core 210 includes components for coordinating and operating cores 202A-202N during multi-threaded processing. System agent core 210 may additionally include a power control unit (PCU), which includes logic and components to regulate the power state of processor cores 202A-202N and graphics processor 208.

In some embodiments, processor 200 additionally includes graphics processor 208 to execute graphics processing operations. In some embodiments, the graphics processor 208 couples with the set of shared cache units 206, and the system agent core 210, including the one or more integrated memory controllers 214. In some embodiments, a display controller 211 is coupled with the graphics processor 208 to drive graphics processor output to one or more coupled displays. In some embodiments, display controller 211 may be a separate module coupled with the graphics processor via at least one interconnect, or may be integrated within the graphics processor 208 or system agent core 210.

In some embodiments, a ring based interconnect unit 212 is used to couple the internal components of the processor 200. However, an alternative interconnect unit may be used, such as a point-to-point interconnect, a switched interconnect, or other techniques, including techniques well known in the art. In some embodiments, graphics processor 208 couples with the ring interconnect 212 via an I/O link 213.

The exemplary I/O link 213 represents at least one of multiple varieties of I/O interconnects, including an on package I/O interconnect which facilitates communication between various processor components and a high-performance embedded memory module 218, such as an eDRAM module. In some embodiments, each of the processor cores 202-202N and graphics processor 208 use embedded memory modules 218 as a shared Last Level Cache.

In some embodiments, processor cores 202A-202N are homogenous cores executing the same instruction set architecture. In another embodiment, processor cores 202A-202N are heterogeneous in terms of instruction set architecture (ISA), where one or more of processor cores 202A-N execute a first instruction set, while at least one of the other cores executes a subset of the first instruction set or a different instruction set. In one embodiment processor cores 202A-202N are heterogeneous in terms of microarchitecture, where one or more cores having a relatively higher power consumption couple with one or more power cores having a lower power consumption. Additionally, processor 200 can be implemented on one or more chips or as an SoC integrated circuit having the illustrated components, in addition to other components.

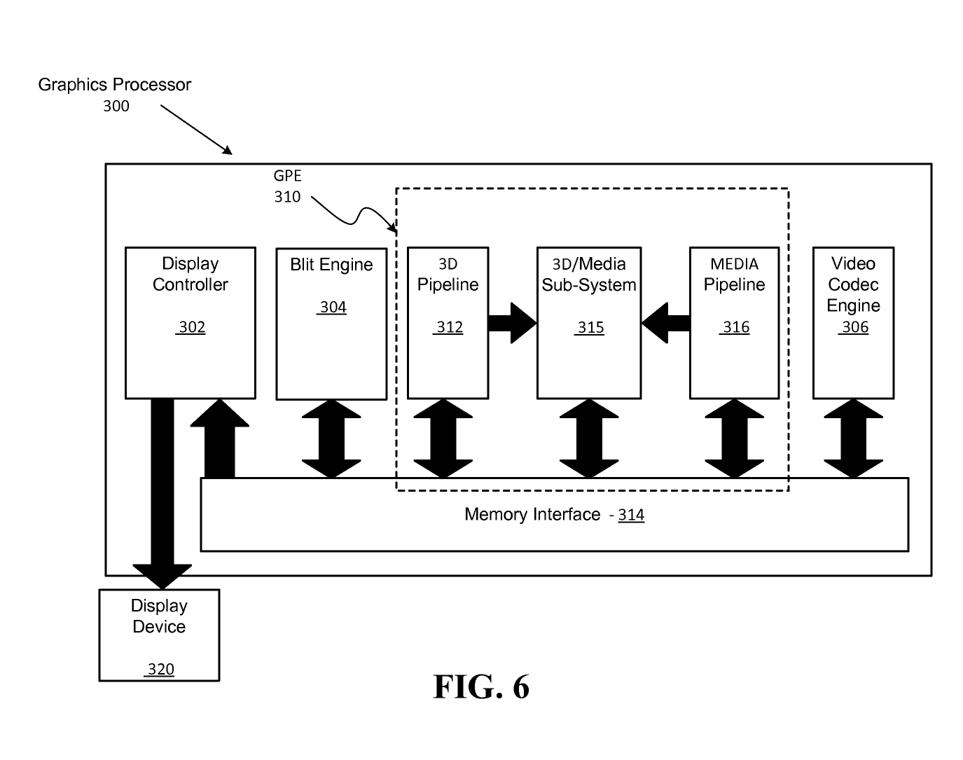

FIG. 6 is a block diagram of a graphics processor 300, which may be a discrete graphics processing unit, or may be a graphics processor integrated with a plurality of processing cores. In some embodiments, the graphics processor communicates via a memory mapped I/O interface to registers on the graphics processor and with commands placed into the processor memory. In some embodiments, graphics processor 300 includes a memory interface 314 to access memory. Memory interface 314 can be an interface to local memory, one or more internal caches, one or more shared external caches, and/or to system memory.

In some embodiments, graphics processor 300 also includes a display controller 302 to drive display output data to a display device 320. Display controller 302 includes hardware for one or more overlay planes for the display and composition of multiple layers of video or user interface elements. In some embodiments, graphics processor 300 includes a video codec engine 306 to encode, decode, or transcode media to, from, or between one or more media encoding formats, including, but not limited to Moving Picture Experts Group (MPEG) formats such as MPEG-2, Advanced Video Coding (AVC) formats such as H.264/MPEG-4 AVC, as well as the Society of Motion Picture & Television Engineers (SMPTE) 421M/VC-1, and Joint Photographic Experts Group (JPEG) formats such as JPEG, and Motion JPEG (MJPEG) formats.

In some embodiments, graphics processor 300 includes a block image transfer (BLIT) engine 304 to perform two-dimensional (2D) rasterizer operations including, for example, bit-boundary block transfers. However, in one embodiment, 2D graphics operations are performed using one or more components of graphics processing engine (GPE) 310. In some embodiments, graphics processing engine 310 is a compute engine for performing graphics operations, including three-dimensional (3D) graphics operations and media operations.

In some embodiments, GPE 310 includes a 3D pipeline 312 for performing 3D operations, such as rendering three-dimensional images and scenes using processing functions that act upon 3D primitive shapes (e.g., rectangle, triangle, etc.). The 3D pipeline 312 includes programmable and fixed function elements that perform various tasks within the element and/or spawn execution threads to a 3D/Media sub-system 315. While 3D pipeline 312 can be used to perform media operations, an embodiment of GPE 310 also includes a media pipeline 316 that is specifically used to perform media operations, such as video post-processing and image enhancement.

In some embodiments, media pipeline 316 includes fixed function or programmable logic units to perform one or more specialized media operations, such as video decode acceleration, video de-interlacing, and video encode acceleration in place of, or on behalf of video codec engine 306. In some embodiments, media pipeline 316 additionally includes a thread spawning unit to spawn threads for execution on 3D/Media sub-system 315. The spawned threads perform computations for the media operations on one or more graphics execution units included in 3D/Media sub-system 315.

In some embodiments, 3D/Media subsystem 315 includes logic for executing threads spawned by 3D pipeline 312 and media pipeline 316. In one embodiment, the pipelines send thread execution requests to 3D/Media subsystem 315, which includes thread dispatch logic for arbitrating and dispatching the various requests to available thread execution resources. The execution resources include an array of graphics execution units to process the 3D and media threads. In some embodiments, 3D/Media subsystem 315 includes one or more internal caches for thread instructions and data. In some embodiments, the subsystem also includes shared memory, including registers and addressable memory, to share data between threads and to store output data.

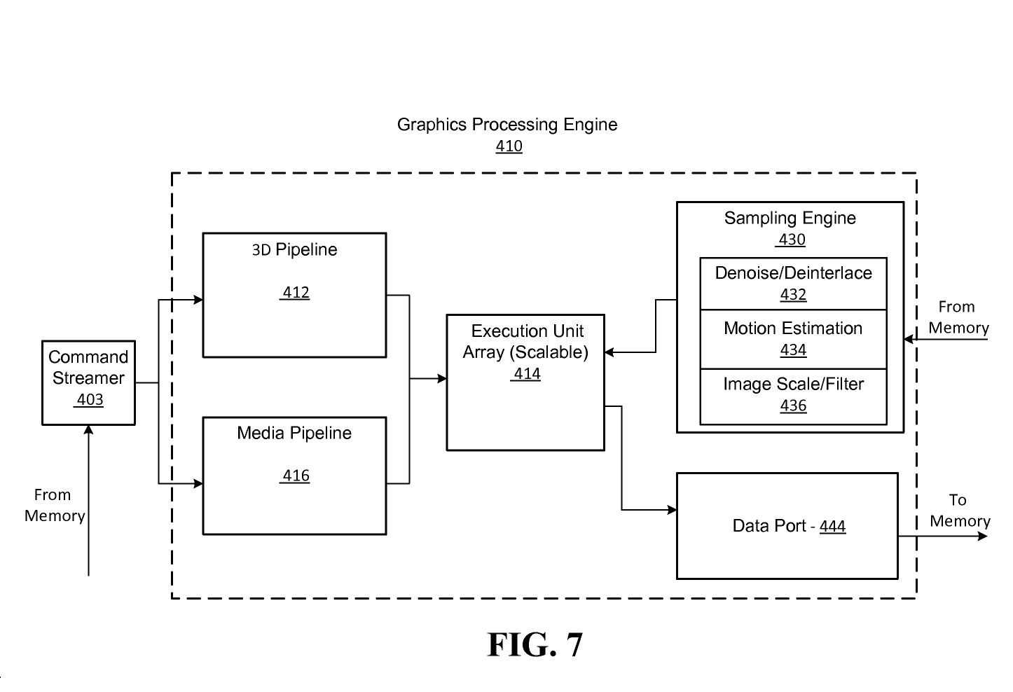

3D/Media Processing—FIG. 7

FIG. 7 is a block diagram of a graphics processing engine 410 of a graphics processor in accordance with some embodiments. In one embodiment, the GPE 410 is a version of the GPE 310 shown in FIG. 6. Elements of FIG. 7 having the same reference numbers (or names) as the elements of any other figure herein can operate or function in any manner similar to that described elsewhere herein, but are not limited to such.

In some embodiments, GPE 410 couples with a command streamer 403, which provides a command stream to the GPE 3D and media pipelines 412, 416. In some embodiments, command streamer 403 is coupled to memory, which can be system memory, or one or more of internal cache memory and shared cache memory. In some embodiments, command streamer 403 receives commands from the memory and sends the commands to 3D pipeline 412 and/or media pipeline 416. The commands are directives fetched from a ring buffer, which stores commands for the 3D and media pipelines 412, 416. In one embodiment, the ring buffer can additionally include batch command buffers storing batches of multiple commands. The 3D and media pipelines 412, 416 process the commands by performing operations via logic within the respective pipelines or by dispatching one or more execution threads to an execution unit array 414. In some embodiments, execution unit array 414 is scalable, such that the array includes a variable number of execution units based on the target power and performance level of GPE 410.

In some embodiments, a sampling engine 430 couples with memory (e.g., cache memory or system memory) and execution unit array 414. In some embodiments, sampling engine 430 provides a memory access mechanism for execution unit array 414 that allows execution array 414 to read graphics and media data from memory. In some embodiments, sampling engine 430 includes logic to perform specialized image sampling operations for media.

In some embodiments, the specialized media sampling logic in sampling engine 430 includes a de-noise/de-interlace module 432, a motion estimation module 434, and an image scaling and filtering module 436. In some embodiments, de-noise/de-interlace module 432 includes logic to perform one or more of a de-noise or a de-interlace algorithm on decoded video data. The de-interlace logic combines alternating fields of interlaced video content into a single fame of video. The de-noise logic reduces or removes data noise from video and image data. In some embodiments, the de-noise logic and de-interlace logic are motion adaptive and use spatial or temporal filtering based on the amount of motion detected in the video data. In some embodiments, the de-noise/de-interlace module 432 includes dedicated motion detection logic (e.g., within the motion estimation engine 434).

In some embodiments, motion estimation engine 434 provides hardware acceleration for video operations by performing video acceleration functions such as motion vector estimation and prediction on video data. The motion estimation engine determines motion vectors that describe the transformation of image data between successive video frames. In some embodiments, a graphics processor media codec uses video motion estimation engine 434 to perform operations on video at the macro-block level that may otherwise be too computationally intensive to perform with a general-purpose processor. In some embodiments, motion estimation engine 434 is generally available to graphics processor components to assist with video decode and processing functions that are sensitive or adaptive to the direction or magnitude of the motion within video data.

In some embodiments, image scaling and filtering module 436 performs image-processing operations to enhance the visual quality of generated images and video. In some embodiments, scaling and filtering module 436 processes image and video data during the sampling operation before providing the data to execution unit array 414.

In some embodiments, the GPE 410 includes a data port 444, which provides an additional mechanism for graphics subsystems to access memory. In some embodiments, data port 444 facilitates memory access for operations including render target writes, constant buffer reads, scratch memory space reads/writes, and media surface accesses. In some embodiments, data port 444 includes cache memory space to cache accesses to memory. The cache memory can be a single data cache or separated into multiple caches for the multiple subsystems that access memory via the data port (e.g., a render buffer cache, a constant buffer cache, etc.). In some embodiments, threads executing on an execution unit in execution unit array 414 communicate with the data port by exchanging messages via a data distribution interconnect that couples each of the sub-systems of GPE 410.

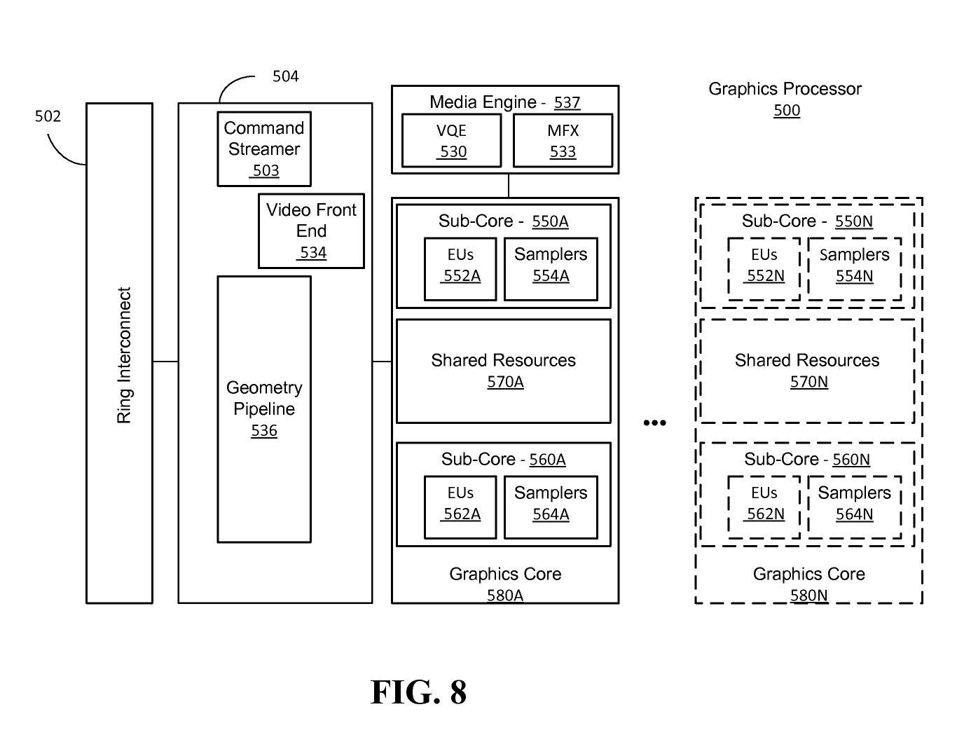

Execution Units—FIGS. 8-10

FIG. 8 is a block diagram of another embodiment of a graphics processor 500. Elements of FIG. 8 having the same reference numbers (or names) as the elements of any other figure herein can operate or function in any manner similar to that described elsewhere herein, but are not limited to such.

In some embodiments, graphics processor 500 includes a ring interconnect 502, a pipeline front-end 504, a media engine 537, and graphics cores 580A-580N. In some embodiments, ring interconnect 502 couples the graphics processor to other processing units, including other graphics processors or one or more general-purpose processor cores. In some embodiments, the graphics processor is one of many processors integrated within a multi-core processing system.

In some embodiments, graphics processor 500 receives batches of commands via ring interconnect 502. The incoming commands are interpreted by a command streamer 503 in the pipeline front-end 504. In some embodiments, graphics processor 500 includes scalable execution logic to perform 3D geometry processing and media processing via the graphics core(s) 580A-580N. For 3D geometry processing commands, command streamer 503 supplies commands to geometry pipeline 536. For at least some media processing commands, command streamer 503 supplies the commands to a video front end 534, which couples with a media engine 537. In some embodiments, media engine 537 includes a Video Quality Engine (VQE) 530 for video and image post-processing and a multi-format encode/decode (MFX) 533 engine to provide hardware-accelerated media data encode and decode. In some embodiments, geometry pipeline 536 and media engine 537 each generate execution threads for the thread execution resources provided by at least one graphics core 580A.

In some embodiments, graphics processor 500 includes scalable thread execution resources featuring modular cores 580A-580N (sometimes referred to as core slices), each having multiple sub-cores 550A-550N, 560A-560N (sometimes referred to as core sub-slices). In some embodiments, graphics processor 500 can have any number of graphics cores 580A through 580N. In some embodiments, graphics processor 500 includes a graphics core 580A having at least a first sub-core 550A and a second core sub-core 560A. In other embodiments, the graphics processor is a low power processor with a single sub-core (e.g., 550A). In some embodiments, graphics processor 500 includes multiple graphics cores 580A-580N, each including a set of first sub-cores 550A-550N and a set of second sub-cores 560A-560N. Each sub-core in the set of first sub-cores 550A-550N includes at least a first set of execution units 552A-552N and media/texture samplers 554A-554N. Each sub-core in the set of second sub-cores 560A-560N includes at least a second set of execution units 562A-562N and samplers 564A-564N. In some embodiments, each sub-core 550A-550N, 560A-560N shares a set of shared resources 570A-570N. In some embodiments, the shared resources include shared cache memory and pixel operation logic. Other shared resources may also be included in the various embodiments of the graphics processor.

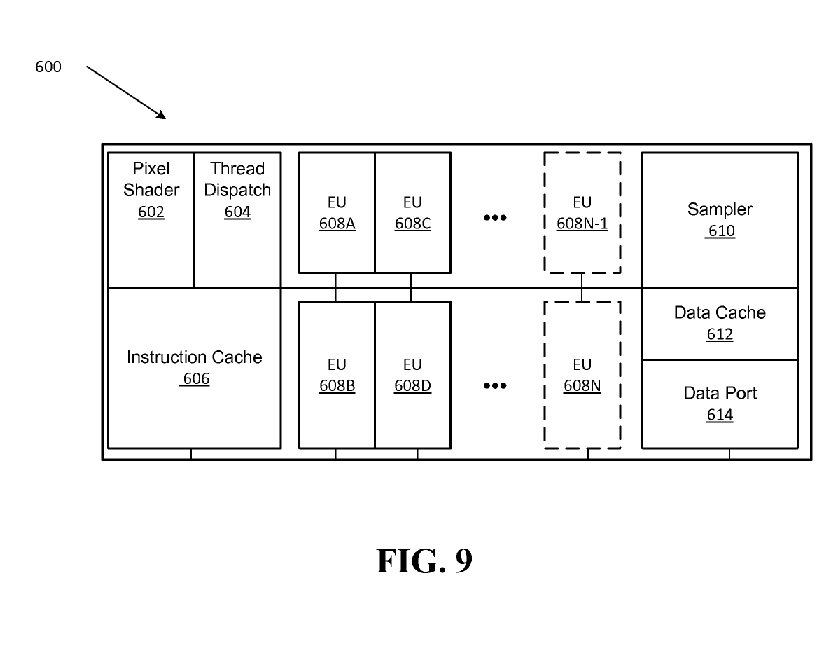

FIG. 9 illustrates thread execution logic 600 including an array of processing elements employed in some embodiments of a GPE. Elements of FIG. 9 having the same reference numbers (or names) as the elements of any other figure herein can operate or function in any manner similar to that described elsewhere herein, but are not limited to such.

In some embodiments, thread execution logic 600 includes a pixel shader 602, a thread dispatcher 604, instruction cache 606, a scalable execution unit array including a plurality of execution units 608A-608N, a sampler 610, a data cache 612, and a data port 614. In one embodiment the included components are interconnected via an interconnect fabric that links to each of the components. In some embodiments, thread execution logic 600 includes one or more connections to memory, such as system memory or cache memory, through one or more of instruction cache 606, data port 614, sampler 610, and execution unit array 608A-608N. In some embodiments, each execution unit (e.g. 608A) is an individual vector processor capable of executing multiple simultaneous threads and processing multiple data elements in parallel for each thread. In some embodiments, execution unit array 608A-608N includes any number individual execution units.

In some embodiments, execution unit array 608A-608N is primarily used to execute “shader” programs. In some embodiments, the execution units in array 608A-608N execute an instruction set that includes native support for many standard 3D graphics shader instructions, such that shader programs from graphics libraries (e.g., Direct 3D and OpenGL) are executed with a minimal translation. The execution units support vertex and geometry processing (e.g., vertex programs, geometry programs, vertex shaders), pixel processing (e.g., pixel shaders, fragment shaders) and general-purpose processing (e.g., compute and media shaders).

Each execution unit in execution unit array 608A-608N operates on arrays of data elements. The number of data elements is the “execution size,” or the number of channels for the instruction. An execution channel is a logical unit of execution for data element access, masking, and flow control within instructions. The number of channels may be independent of the number of physical Arithmetic Logic Units (ALUs) or Floating Point Units (FPUs) for a particular graphics processor. In some embodiments, execution units 608A-608N support integer and floating-point data types.

The execution unit instruction set includes single instruction multiple data (SIMD) instructions. The various data elements can be stored as a packed data type in a register and the execution unit will process the various elements based on the data size of the elements. For example, when operating on a 256-bit wide vector, the 256 bits of the vector are stored in a register and the execution unit operates on the vector as four separate 64-bit packed data elements (Quad-Word (QW) size data elements), eight separate 32-bit packed data elements (Double Word (DW) size data elements), sixteen separate 16-bit packed data elements (Word (W) size data elements), or thirty-two separate 8-bit data elements (byte (B) size data elements). However, different vector widths and register sizes are possible.

One or more internal instruction caches (e.g., 606) are included in the thread execution logic 600 to cache thread instructions for the execution units. In some embodiments, one or more data caches (e.g., 612) are included to cache thread data during thread execution. In some embodiments, sampler 610 is included to provide texture sampling for 3D operations and media sampling for media operations. In some embodiments, sampler 610 includes specialized texture or media sampling functionality to process texture or media data during the sampling process before providing the sampled data to an execution unit.

During execution, the graphics and media pipelines send thread initiation requests to thread execution logic 600 via thread spawning and dispatch logic. In some embodiments, thread execution logic 600 includes a local thread dispatcher 604 that arbitrates thread initiation requests from the graphics and media pipelines and instantiates the requested threads on one or more execution units 608A-608N. For example, the geometry pipeline (e.g., 536 of FIG. 8) dispatches vertex processing, tessellation, or geometry processing threads to thread execution logic 600 (FIG. 9). In some embodiments, thread dispatcher 604 can also process runtime thread spawning requests from the executing shader programs.

Once a group of geometric objects has been processed and rasterized into pixel data, pixel shader 602 is invoked to further compute output information and cause results to be written to output surfaces (e.g., color buffers, depth buffers, stencil buffers, etc.). In some embodiments, pixel shader 602 calculates the values of the various vertex attributes that are to be interpolated across the rasterized object. In some embodiments, pixel shader 602 then executes an application programming interface (API)-supplied pixel shader program. To execute the pixel shader program, pixel shader 602 dispatches threads to an execution unit (e.g., 608A) via thread dispatcher 604. In some embodiments, pixel shader 602 uses texture sampling logic in sampler 610 to access texture data in texture maps stored in memory. Arithmetic operations on the texture data and the input geometry data compute pixel color data for each geometric fragment, or discards one or more pixels from further processing.

In some embodiments, the data port 614 provides a memory access mechanism for the thread execution logic 600 output processed data to memory for processing on a graphics processor output pipeline. In some embodiments, the data port 614 includes or couples to one or more cache memories (e.g., data cache 612) to cache data for memory access via the data port.

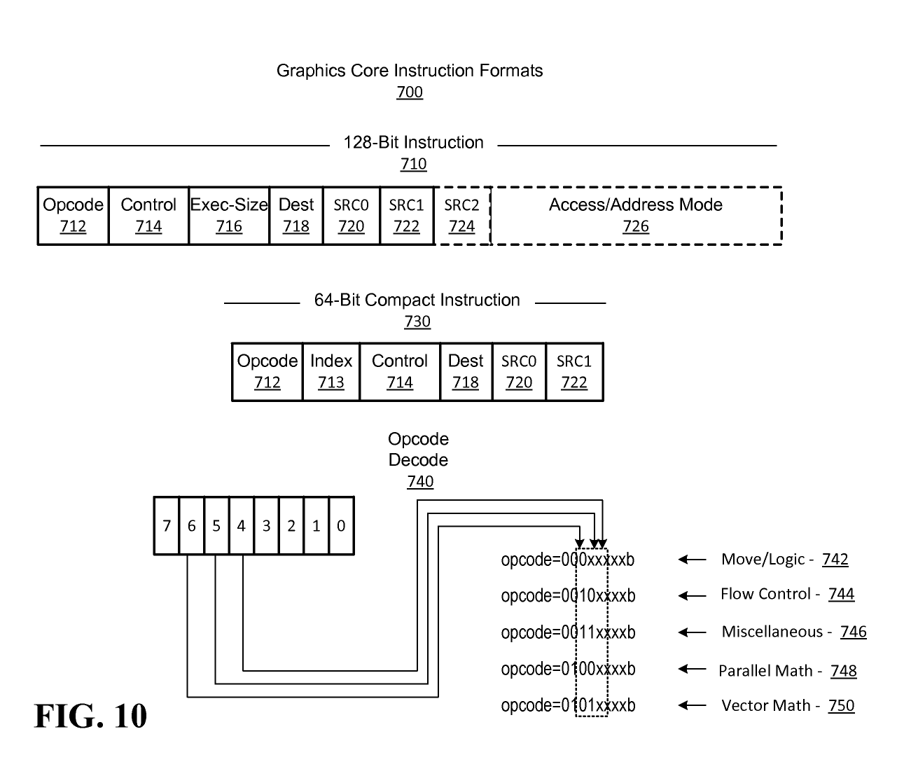

FIG. 10 is a block diagram illustrating a graphics processor instruction formats 700 according to some embodiments. In one or more embodiment, the graphics processor execution units support an instruction set having instructions in multiple formats. The solid lined boxes illustrate the components that are generally included in an execution unit instruction, while the dashed lines include components that are optional or that are only included in a sub-set of the instructions. In some embodiments, instruction format 700 described and illustrated are macro-instructions, in that they are instructions supplied to the execution unit, as opposed to micro-operations resulting from instruction decode once the instruction is processed.

In some embodiments, the graphics processor execution units natively support instructions in a 128-bit format 710. A 64-bit compacted instruction format 730 is available for some instructions based on the selected instruction, instruction options, and number of operands. The native 128-bit format 710 provides access to all instruction options, while some options and operations are restricted in the 64-bit format 730. The native instructions available in the 64-bit format 730 vary by embodiment. In some embodiments, the instruction is compacted in part using a set of index values in an index field 713. The execution unit hardware references a set of compaction tables based on the index values and uses the compaction table outputs to reconstruct a native instruction in the 128-bit format 710.

For each format, instruction opcode 712 defines the operation that the execution unit is to perform. The execution units execute each instruction in parallel across the multiple data elements of each operand. For example, in response to an add instruction the execution unit performs a simultaneous add operation across each color channel representing a texture element or picture element. By default, the execution unit performs each instruction across all data channels of the operands. In some embodiments, instruction control field 714 enables control over certain execution options, such as channels selection (e.g., predication) and data channel order (e.g., swizzle). For 128-bit instructions 710 an exec-size field 716 limits the number of data channels that will be executed in parallel. In some embodiments, exec-size field 716 is not available for use in the 64-bit compact instruction format 730.

Some execution unit instructions have up to three operands including two source operands, src0 722, src1 722, and one destination 718. In some embodiments, the execution units support dual destination instructions, where one of the destinations is implied. Data manipulation instructions can have a third source operand (e.g., SRC2 724), where the instruction opcode 712 determines the number of source operands. An instruction's last source operand can be an immediate (e.g., hard-coded) value passed with the instruction.

In some embodiments, the 128-bit instruction format 710 includes an access/address mode information 726 specifying, for example, whether direct register addressing mode or indirect register addressing mode is used. When direct register addressing mode is used, the register address of one or more operands is directly provided by bits in the instruction 710.

In some embodiments, the 128-bit instruction format 710 includes an access/address mode field 726, which specifies an address mode and/or an access mode for the instruction. In one embodiment the access mode to define a data access alignment for the instruction. Some embodiments support access modes including a 16-byte aligned access mode and a 1-byte aligned access mode, where the byte alignment of the access mode determines the access alignment of the instruction operands. For example, when in a first mode, the instruction 710 may use byte-aligned addressing for source and destination operands and when in a second mode, the instruction 710 may use 16-byte-aligned addressing for all source and destination operands.

In one embodiment, the address mode portion of the access/address mode field 726 determines whether the instruction is to use direct or indirect addressing. When direct register addressing mode is used bits in the instruction 710 directly provide the register address of one or more operands. When indirect register addressing mode is used, the register address of one or more operands may be computed based on an address register value and an address immediate field in the instruction.

In some embodiments instructions are grouped based on opcode 712 bit-fields to simplify Opcode decode 740. For an 8-bit opcode, bits 4, 5, and 6 allow the execution unit to determine the type of opcode. The precise opcode grouping shown is merely an example. In some embodiments, a move and logic opcode group 742 includes data movement and logic instructions (e.g., move (mov), compare (cmp)). In some embodiments, move and logic group 742 shares the five most significant bits (MSB), where move (mov) instructions are in the form of 0000xxxxb and logic instructions are in the form of 0001xxxxb. A flow control instruction group 744 (e.g., call, jump (jmp)) includes instructions in the form of 0010xxxxb (e.g., 0x20). A miscellaneous instruction group 746 includes a mix of instructions, including synchronization instructions (e.g., wait, send) in the form of 0011xxxxb (e.g., 0x30). A parallel math instruction group 748 includes component-wise arithmetic instructions (e.g., add, multiply (mul)) in the form of 0100xxxxb (e.g., 0x40). The parallel math group 748 performs the arithmetic operations in parallel across data channels. The vector math group 750 includes arithmetic instructions (e.g., dp4) in the form of 0101xxxxb (e.g., 0x50). The vector math group performs arithmetic such as dot product calculations on vector operands.

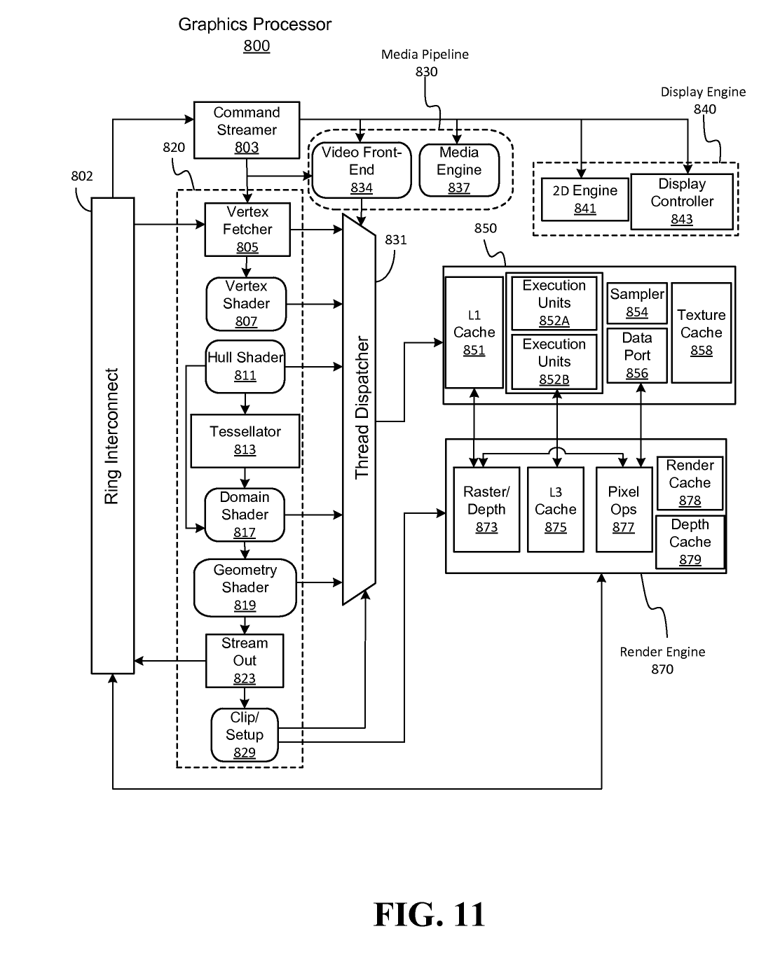

Graphics Pipeline—FIG. 11

FIG. 11 is a block diagram of another embodiment of a graphics processor 800. Elements of FIG. 11 having the same reference numbers (or names) as the elements of any other figure herein can operate or function in any manner similar to that described elsewhere herein, but are not limited to such.

In some embodiments, graphics processor 800 includes a graphics pipeline 820, a media pipeline 830, a display engine 840, thread execution logic 850, and a render output pipeline 870. In some embodiments, graphics processor 800 is a graphics processor within a multi-core processing system that includes one or more general purpose processing cores. The graphics processor is controlled by register writes to one or more control registers (not shown) or via commands issued to graphics processor 800 via a ring interconnect 802. In some embodiments, ring interconnect 802 couples graphics processor 800 to other processing components, such as other graphics processors or general-purpose processors. Commands from ring interconnect 802 are interpreted by a command streamer 803, which supplies instructions to individual components of graphics pipeline 820 or media pipeline 830.

In some embodiments, command streamer 803 directs the operation of a vertex fetcher 805 that reads vertex data from memory and executes vertex-processing commands provided by command streamer 803. In some embodiments, vertex fetcher 805 provides vertex data to a vertex shader 807, which performs coordinate space transformation and lighting operations to each vertex. In some embodiments, vertex fetcher 805 and vertex shader 807 execute vertex-processing instructions by dispatching execution threads to execution units 852A, 852B via a thread dispatcher 831.

In some embodiments, execution units 852A, 852B are an array of vector processors having an instruction set for performing graphics and media operations. In some embodiments, execution units 852A, 852B have an attached L1 cache 851 that is specific for each array or shared between the arrays. The cache can be configured as a data cache, an instruction cache, or a single cache that is partitioned to contain data and instructions in different partitions.

In some embodiments, graphics pipeline 820 includes tessellation components to perform hardware-accelerated tessellation of 3D objects. In some embodiments, a programmable hull shader 811 configures the tessellation operations. A programmable domain shader 817 provides back-end evaluation of tessellation output. A tessellator 813 operates at the direction of hull shader 811 and contains special purpose logic to generate a set of detailed geometric objects based on a coarse geometric model that is provided as input to graphics pipeline 820. In some embodiments, if tessellation is not used, tessellation components 811, 813, 817 can be bypassed.

In some embodiments, complete geometric objects can be processed by a geometry shader 819 via one or more threads dispatched to execution units 852A, 852B, or can proceed directly to the clipper 829. In some embodiments, the geometry shader operates on entire geometric objects, rather than vertices or patches of vertices as in previous stages of the graphics pipeline. If the tessellation is disabled the geometry shader 819 receives input from the vertex shader 807. In some embodiments, geometry shader 819 is programmable by a geometry shader program to perform geometry tessellation if the tessellation units are disabled.

Before rasterization, a clipper 829 processes vertex data. The clipper 829 may be a fixed function clipper or a programmable clipper having clipping and geometry shader functions. In some embodiments, a rasterizer/depth 873 in the render output pipeline 870 dispatches pixel shaders to convert the geometric objects into their per pixel representations. In some embodiments, pixel shader logic is included in thread execution logic 850. In some embodiments, an application can bypass the rasterizer 873 and access un-rasterized vertex data via a stream out unit 823.

The graphics processor 800 has an interconnect bus, interconnect fabric, or some other interconnect mechanism that allows data and message passing amongst the major components of the processor. In some embodiments, execution units 852A, 852B and associated cache(s) 851, texture and media sampler 854, and texture/sampler cache 858 interconnect via a data port 856 to perform memory access and communicate with render output pipeline components of the processor. In some embodiments, sampler 854, caches 851, 858 and execution units 852A, 852B each have separate memory access paths.

In some embodiments, render output pipeline 870 contains a rasterizer and depth test component 873 that converts vertex-based objects into an associated pixel-based representation. In some embodiments, the rasterizer logic includes a windower/masker unit to perform fixed function triangle and line rasterization. An associated render cache 878 and depth cache 879 are also available in some embodiments. A pixel operations component 877 performs pixel-based operations on the data, though in some instances, pixel operations associated with 2D operations (e.g. bit block image transfers with blending) are performed by the 2D engine 841, or substituted at display time by the display controller 843 using overlay display planes. In some embodiments, a shared L3 cache 875 is available to all graphics components, allowing the sharing of data without the use of main system memory.

In some embodiments, graphics processor media pipeline 830 includes a media engine 837 and a video front end 834. In some embodiments, video front end 834 receives pipeline commands from the command streamer 803. In some embodiments, media pipeline 830 includes a separate command streamer. In some embodiments, video front-end 834 processes media commands before sending the command to the media engine 837. In some embodiments, media engine 337 includes thread spawning functionality to spawn threads for dispatch to thread execution logic 850 via thread dispatcher 831.

In some embodiments, graphics processor 800 includes a display engine 840. In some embodiments, display engine 840 is external to processor 800 and couples with the graphics processor via the ring interconnect 802, or some other interconnect bus or fabric. In some embodiments, display engine 840 includes a 2D engine 841 and a display controller 843. In some embodiments, display engine 840 contains special purpose logic capable of operating independently of the 3D pipeline. In some embodiments, display controller 843 couples with a display device (not shown), which may be a system integrated display device, as in a laptop computer, or an external display device attached via a display device connector.

In some embodiments, graphics pipeline 820 and media pipeline 830 are configurable to perform operations based on multiple graphics and media programming interfaces and are not specific to any one application programming interface (API). In some embodiments, driver software for the graphics processor translates API calls that are specific to a particular graphics or media library into commands that can be processed by the graphics processor. In some embodiments, support is provided for the Open Graphics Library (OpenGL) and Open Computing Language (OpenCL) from the Khronos Group, the Direct3D library from the Microsoft Corporation, or support may be provided to both OpenGL and D3D. Support may also be provided for the Open Source Computer Vision Library (OpenCV). A future API with a compatible 3D pipeline would also be supported if a mapping can be made from the pipeline of the future API to the pipeline of the graphics processor.

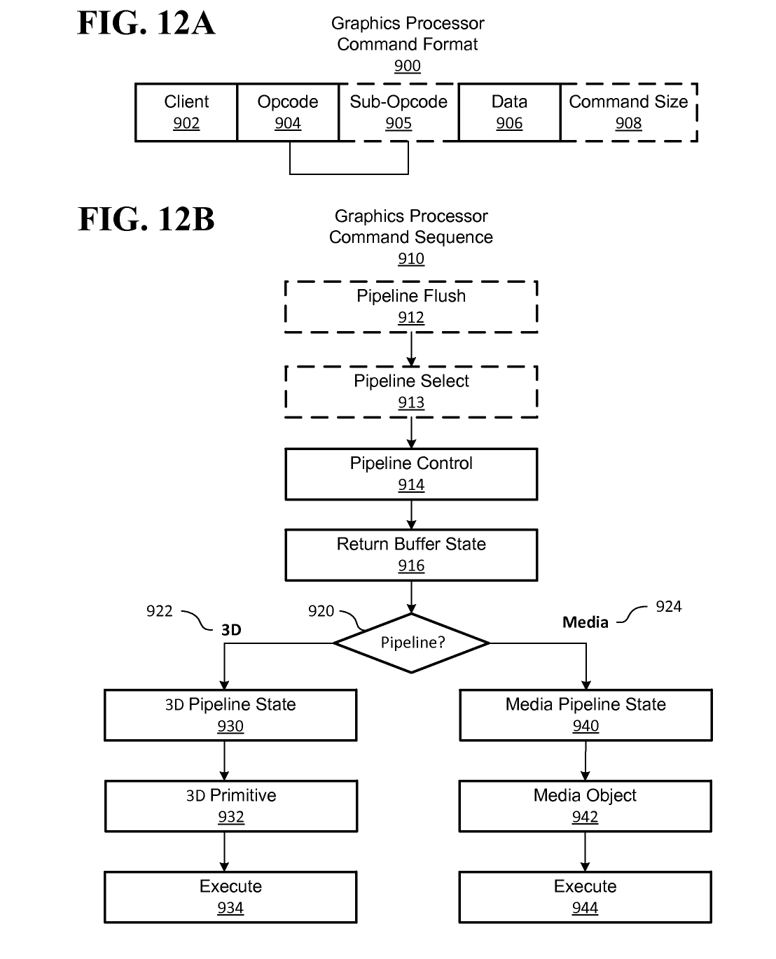

Graphics Pipeline Programming—FIGS. 12A-12B

FIG. 12A is a block diagram illustrating a graphics processor command format 900 according to some embodiments. FIG. 12B is a block diagram illustrating a graphics processor command sequence 910 according to an embodiment. The solid lined boxes in FIG. 12A illustrate the components that are generally included in a graphics command while the dashed lines include components that are optional or that are only included in a sub-set of the graphics commands. The exemplary graphics processor command format 900 of FIG. 12A includes data fields to identify a target client 902 of the command, a command operation code (opcode) 904, and the relevant data 906 for the command. A sub-opcode 905 and a command size 908 are also included in some commands.

In some embodiments, client 902 specifies the client unit of the graphics device that processes the command data. In some embodiments, a graphics processor command parser examines the client field of each command to condition the further processing of the command and route the command data to the appropriate client unit. In some embodiments, the graphics processor client units include a memory interface unit, a render unit, a 2D unit, a 3D unit, and a media unit. Each client unit has a corresponding processing pipeline that processes the commands. Once the command is received by the client unit, the client unit reads the opcode 904 and, if present, sub-opcode 905 to determine the operation to perform. The client unit performs the command using information in data field 906. For some commands an explicit command size 908 is expected to specify the size of the command. In some embodiments, the command parser automatically determines the size of at least some of the commands based on the command opcode. In some embodiments commands are aligned via multiples of a double word.

The flow diagram in FIG. 12B shows an exemplary graphics processor command sequence 910. In some embodiments, software or firmware of a data processing system that features an embodiment of a graphics processor uses a version of the command sequence shown to set up, execute, and terminate a set of graphics operations. A sample command sequence is shown and described for purposes of example only as embodiments are not limited to these specific commands or to this command sequence. Moreover, the commands may be issued as batch of commands in a command sequence, such that the graphics processor will process the sequence of commands in at least partially concurrence.

In some embodiments, the graphics processor command sequence 910 may begin with a pipeline flush command 912 to cause any active graphics pipeline to complete the currently pending commands for the pipeline. In some embodiments, the 3D pipeline 922 and the media pipeline 924 do not operate concurrently. The pipeline flush is performed to cause the active graphics pipeline to complete any pending commands. In response to a pipeline flush, the command parser for the graphics processor will pause command processing until the active drawing engines complete pending operations and the relevant read caches are invalidated. Optionally, any data in the render cache that is marked ‘dirty’ can be flushed to memory. In some embodiments, pipeline flush command 912 can be used for pipeline synchronization or before placing the graphics processor into a low power state.

In some embodiments, a pipeline select command 913 is used when a command sequence requires the graphics processor to explicitly switch between pipelines. In some embodiments, a pipeline select command 913 is required only once within an execution context before issuing pipeline commands unless the context is to issue commands for both pipelines. In some embodiments, a pipeline flush command is 912 is required immediately before a pipeline switch via the pipeline select command 913.

In some embodiments, a pipeline control command 914 configures a graphics pipeline for operation and is used to program the 3D pipeline 922 and the media pipeline 924. In some embodiments, pipeline control command 914 configures the pipeline state for the active pipeline. In one embodiment, the pipeline control command 914 is used for pipeline synchronization and to clear data from one or more cache memories within the active pipeline before processing a batch of commands.

In some embodiments, return buffer state commands 916 are used to configure a set of return buffers for the respective pipelines to write data. Some pipeline operations require the allocation, selection, or configuration of one or more return buffers into which the operations write intermediate data during processing. In some embodiments, the graphics processor also uses one or more return buffers to store output data and to perform cross thread communication. In some embodiments, the return buffer state 916 includes selecting the size and number of return buffers to use for a set of pipeline operations.

The remaining commands in the command sequence differ based on the active pipeline for operations. Based on a pipeline determination 920, the command sequence is tailored to the 3D pipeline 922 beginning with the 3D pipeline state 930, or the media pipeline 924 beginning at the media pipeline state 940.

The commands for the 3D pipeline state 930 include 3D state setting commands for vertex buffer state, vertex element state, constant color state, depth buffer state, and other state variables that are to be configured before 3D primitive commands are processed. The values of these commands are determined at least in part based the particular 3D API in use. In some embodiments, 3D pipeline state 930 commands are also able to selectively disable or bypass certain pipeline elements if those elements will not be used.

In some embodiments, 3D primitive 932 command is used to submit 3D primitives to be processed by the 3D pipeline. Commands and associated parameters that are passed to the graphics processor via the 3D primitive 932 command are forwarded to the vertex fetch function in the graphics pipeline. The vertex fetch function uses the 3D primitive 932 command data to generate vertex data structures. The vertex data structures are stored in one or more return buffers. In some embodiments, 3D primitive 932 command is used to perform vertex operations on 3D primitives via vertex shaders. To process vertex shaders, 3D pipeline 922 dispatches shader execution threads to graphics processor execution units.

In some embodiments, 3D pipeline 922 is triggered via an execute 934 command or event. In some embodiments, a register write triggers command execution. In some embodiments execution is triggered via a ‘go’ or ‘kick’ command in the command sequence. In one embodiment command execution is triggered using a pipeline synchronization command to flush the command sequence through the graphics pipeline. The 3D pipeline will perform geometry processing for the 3D primitives. Once operations are complete, the resulting geometric objects are rasterized and the pixel engine colors the resulting pixels. Additional commands to control pixel shading and pixel back end operations may also be included for those operations.

In some embodiments, the graphics processor command sequence 910 follows the media pipeline 924 path when performing media operations. In general, the specific use and manner of programming for the media pipeline 924 depends on the media or compute operations to be performed. Specific media decode operations may be offloaded to the media pipeline during media decode. In some embodiments, the media pipeline can also be bypassed and media decode can be performed in whole or in part using resources provided by one or more general purpose processing cores. In one embodiment, the media pipeline also includes elements for general-purpose graphics processor unit (GPGPU) operations, where the graphics processor is used to perform SIMD vector operations using computational shader programs that are not explicitly related to the rendering of graphics primitives.

In some embodiments, media pipeline 924 is configured in a similar manner as the 3D pipeline 922. A set of media pipeline state commands 940 are dispatched or placed into in a command queue before the media object commands 942. In some embodiments, media pipeline state commands 940 include data to configure the media pipeline elements that will be used to process the media objects. This includes data to configure the video decode and video encode logic within the media pipeline, such as encode or decode format. In some embodiments, media pipeline state commands 940 also support the use one or more pointers to “indirect” state elements that contain a batch of state settings.

In some embodiments, media object commands 942 supply pointers to media objects for processing by the media pipeline. The media objects include memory buffers containing video data to be processed. In some embodiments, all media pipeline states must be valid before issuing a media object command 942. Once the pipeline state is configured and media object commands 942 are queued, the media pipeline 924 is triggered via an execute command 944 or an equivalent execute event (e.g., register write). Output from media pipeline 924 may then be post processed by operations provided by the 3D pipeline 922 or the media pipeline 924. In some embodiments, GPGPU operations are configured and executed in a similar manner as media operations.

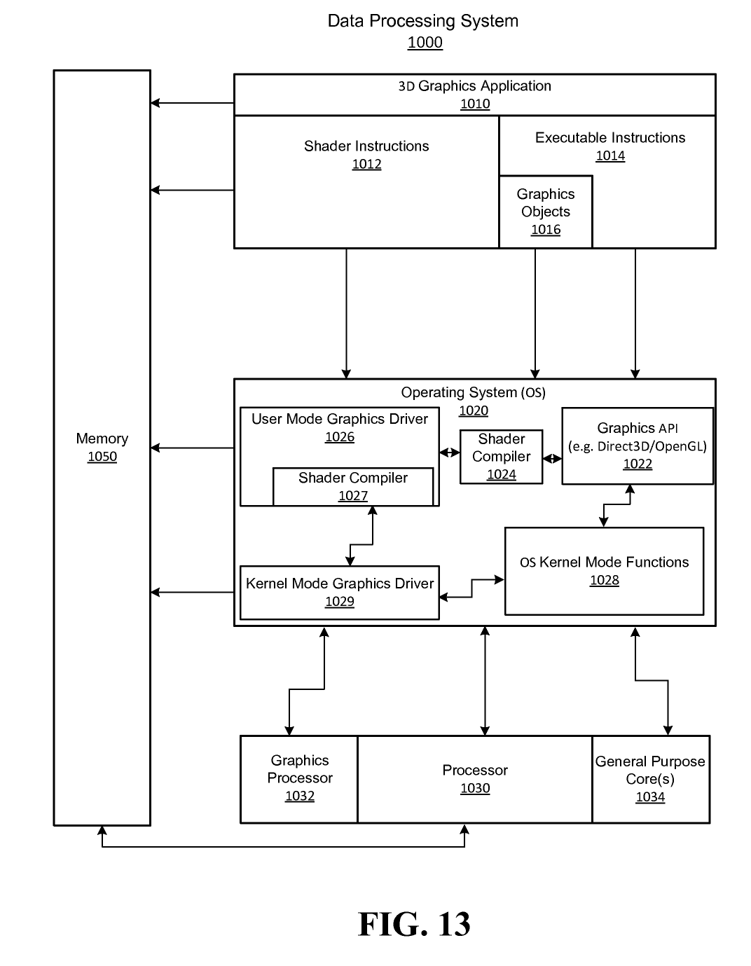

Graphics Software Architecture—FIG. 13

FIG. 13 illustrates exemplary graphics software architecture for a data processing system 1000 according to some embodiments. In some embodiments, software architecture includes a 3D graphics application 1010, an operating system 1020, and at least one processor 1030. In some embodiments, processor 1030 includes a graphics processor 1032 and one or more general-purpose processor core(s) 1034. The graphics application 1010 and operating system 1020 each execute in the system memory 1050 of the data processing system.

In some embodiments, 3D graphics application 1010 contains one or more shader programs including shader instructions 1012. The shader language instructions may be in a high-level shader language, such as the High Level Shader Language (HLSL) or the OpenGL Shader Language (GLSL). The application also includes executable instructions 1014 in a machine language suitable for execution by the general-purpose processor core 1034. The application also includes graphics objects 1016 defined by vertex data.

In some embodiments, operating system 1020 is a Microsoft® Windows® operating system from the Microsoft Corporation, a proprietary UNIX-like operating system, or an open source UNIX-like operating system using a variant of the Linux kernel. When the Direct3D API is in use, the operating system 1020 uses a front-end shader compiler 1024 to compile any shader instructions 1012 in HLSL into a lower-level shader language. The compilation may be a just-in-time (JIT) compilation or the application can perform shader pre-compilation. In some embodiments, high-level shaders are compiled into low-level shaders during the compilation of the 3D graphics application 1010.

In some embodiments, user mode graphics driver 1026 contains a back-end shader compiler 1027 to convert the shader instructions 1012 into a hardware specific representation. When the OpenGL API is in use, shader instructions 1012 in the GLSL high-level language are passed to a user mode graphics driver 1026 for compilation. In some embodiments, user mode graphics driver 1026 uses operating system kernel mode functions 1028 to communicate with a kernel mode graphics driver 1029. In some embodiments, kernel mode graphics driver 1029 communicates with graphics processor 1032 to dispatch commands and instructions.

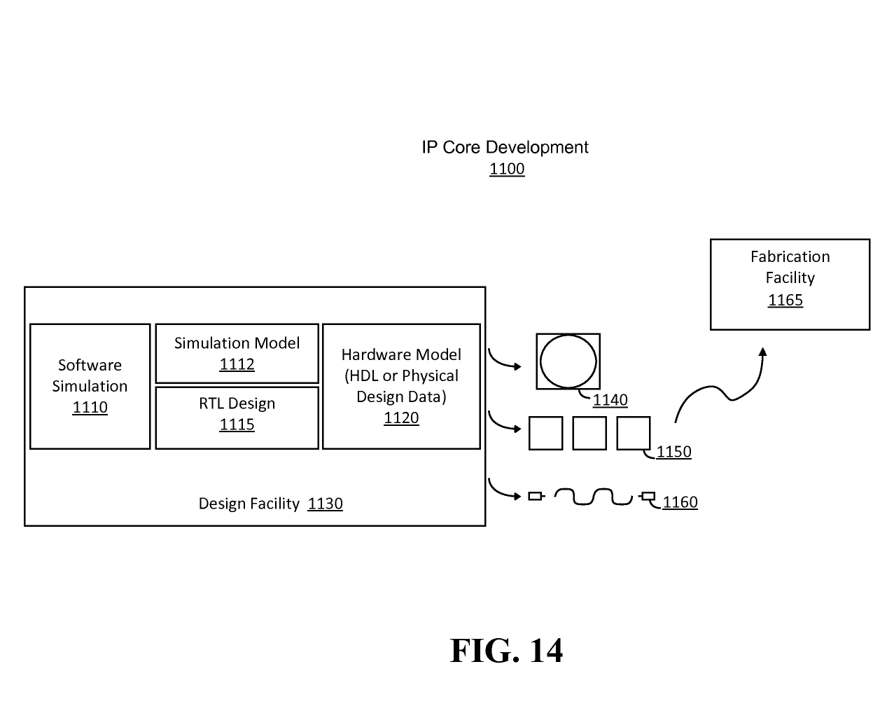

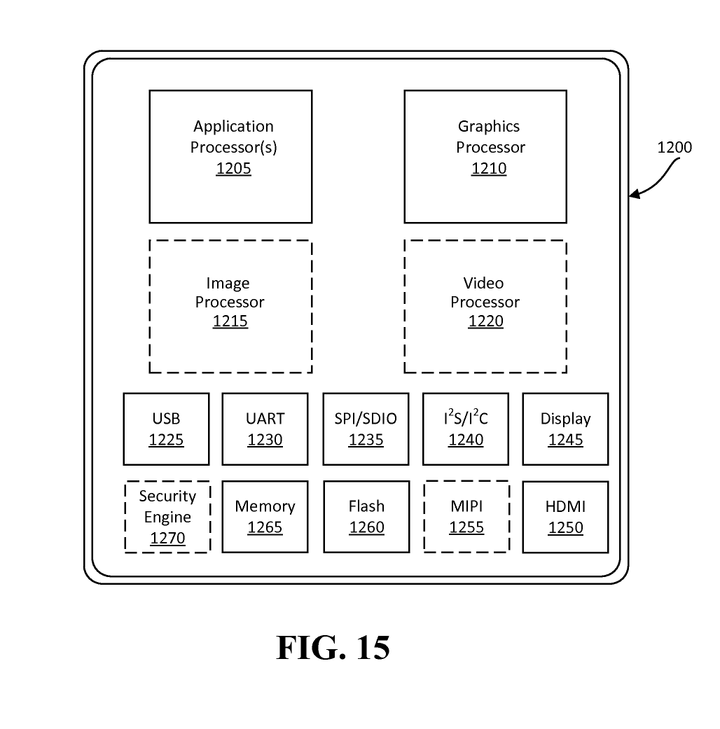

IP Core Implementations—FIGS. 14-15

One or more aspects of at least one embodiment may be implemented by representative code stored on a machine-readable medium which represents and/or defines logic within an integrated circuit such as a processor. For example, the machine-readable medium may include instructions which represent various logic within the processor. When read by a machine, the instructions may cause the machine to fabricate the logic to perform the techniques described herein. Such representations, known as “IP cores,” are reusable units of logic for an integrated circuit that may be stored on a tangible, machine-readable medium as a hardware model that describes the structure of the integrated circuit. The hardware model may be supplied to various customers or manufacturing facilities, which load the hardware model on fabrication machines that manufacture the integrated circuit. The integrated circuit may be fabricated such that the circuit performs operations described in association with any of the embodiments described herein.

FIG. 14 is a block diagram illustrating an IP core development system 1100 that may be used to manufacture an integrated circuit to perform operations according to an embodiment. The IP core development system 1100 may be used to generate modular, re-usable designs that can be incorporated into a larger design or used to construct an entire integrated circuit (e.g., an SOC integrated circuit). A design facility 1130 can generate a software simulation 1110 of an IP core design in a high level programming language (e.g., C/C++). The software simulation 1110 can be used to design, test, and verify the behavior of the IP core using a simulation model 1112. The simulation model 1112 may include functional, behavioral, and/or timing simulations. A register transfer level (RTL) design can then be created or synthesized from the simulation model 1112. The RTL design 1115 is an abstraction of the behavior of the integrated circuit that models the flow of digital signals between hardware registers, including the associated logic performed using the modeled digital signals. In addition to an RTL design 1115, lower-level designs at the logic level or transistor level may also be created, designed, or synthesized. Thus, the particular details of the initial design and simulation may vary.

The RTL design 1115 or equivalent may be further synthesized by the design facility into a hardware model 1120, which may be in a hardware description language (HDL), or some other representation of physical design data. The HDL may be further simulated or tested to verify the IP core design. The IP core design can be stored for delivery to a 3^{rd} party fabrication facility 1165 using non-volatile memory 1140 (e.g., hard disk, flash memory, or any non-volatile storage medium). Alternatively, the IP core design may be transmitted (e.g., via the Internet) over a wired connection 1150 or wireless connection 1160. The fabrication facility 1165 may then fabricate an integrated circuit that is based at least in part on the IP core design. The fabricated integrated circuit can be configured to perform operations in accordance with at least one embodiment described herein.

FIG. 15 is a block diagram illustrating an exemplary system on a chip integrated circuit 1200 that may be fabricated using one or more IP cores, according to an embodiment. The exemplary integrated circuit includes one or more application processors 1205 (e.g., CPUs), at least one graphics processor 1210, and may additionally include an image processor 1215 and/or a video processor 1220, any of which may be a modular IP core from the same or multiple different design facilities. The integrated circuit includes peripheral or bus logic including a USB controller 1225, UART controller 1230, an SPI/SDIO controller 1235, and an I²S/I²C controller 1240. Additionally, the integrated circuit can include a display device 1245 coupled to one or more of a high-definition multimedia interface (HDMI) controller 1250 and a mobile industry processor interface (MIPI) display interface 1255. Storage may be provided by a flash memory subsystem 1260 including flash memory and a flash memory controller. Memory interface may be provided via a memory controller 1265 for access to SDRAM or SRAM memory devices. Some integrated circuits additionally include an embedded security engine 1270.

Additionally, other logic and circuits may be included in the processor of integrated circuit 1200, including additional graphics processors/cores, peripheral interface controllers, or general purpose processor cores.

### ADDITIONAL NOTES AND EXAMPLES

Example 1 may include a computing system to sort a value comprising a hardware execution unit to implement an execution block including a plurality of execution elements, and a sorter including a data exchanger to exchange a value that is to be held by a first execution element of a plurality of execution elements with a value that is to be held by a second execution element of the plurality of execution elements and a data comparator to compare a value that is to be held by the first execution element with the value from the second execution element and a value that is to be held by the second execution element with the value from the first execution element, wherein the values involved in the exchange and the compare are to remain locally sorted and globally shuffled in a final output of the sorter that is to be stored.

Example 2 may include the computing system of Example 1, wherein the sorter is to include one or more of an XOR operator to execute an XOR operation for each of the execution elements based on an execution element identifier (ID) of each of the execution elements and an AND operation to execute an AND operation for each of the execution elements based on the execution element ID of each of the execution elements.

Example 3 may include the computing system of any one of Examples 1 to 2, further including a data storer to store the values in the final output of the sorter to memory in a globally sorted order.

Example 4 may include a sorter to sort a value comprising a data exchanger to exchange a value that is to be held by a first execution element of a plurality of execution elements with a value that is to be held by a second execution element of the plurality of execution elements and a data comparator to compare a value that is to be held by the first execution element with the value from the second execution element and a value that is to be held by the second execution element with the value from the first execution element, wherein the values involved in the exchange and the compare are to remain locally sorted and globally shuffled in a final output of the sorter that is to be stored.

Example 5 may include the sorter of Example 4, wherein a hardware execution unit is to implement an execution block including the plurality of execution elements, wherein the exchange is to occur in a phase of a sorting network, and wherein the compare is to occur in the same phase of the sorting network after the exchange.

Example 6 may include the sorter of any one of Examples 4 to 5, wherein the hardware execution unit is to include an n-wide single instruction multiple data (SIMD) architecture, and wherein each of the execution elements are to utilize a single lane of the SIMD architecture.

Example 7 may include the sorter of any one of Examples 4 to 6, wherein the plurality of execution elements is to include one or more of a plurality of work-items and a plurality of threads.

Example 8 may include the sorter of any one of Examples 4 to 7, wherein the sorter is to sort the values involved in the exchange and the compare based on a pattern of a bitonic sorting network.

Example 9 may include the sorter of any one of Examples 4 to 8, further including a data assigner to assign a pair of vectors each including a set of values to each of the execution elements, wherein the pair of vectors are to be involved in the exchange and the compare.

Example 10 may include the sorter of any one of Examples 4 to 9, further including a combiner to merge two vectors that are each to include a set of values at each of the execution elements to sort the set of values of each of the vectors into a locally sorted order.

Example 11 may include the sorter of any one of Examples 4 to 10, further including a shuffler to directly exchange the value from the first execution element with the value from second execution element without an access to memory.

Example 12 may include the sorter of any one of Examples 4 to 11, further including one or more of an XOR operator to execute an XOR operation for each of the execution elements based on an execution element identifier (ID) of each of the execution elements and an AND operator to execute an AND operation for each of the execution elements based on the execution element ID of each of the execution elements.

Example 13 may include the sorter of any one of Examples 4 to 12, wherein the XOR operator is to execute the XOR operation for each of the execution elements between the execution element identifier ID of each of the execution elements and a number of a stage in a sorting network.

Example 14 may include the sorter of any one of Examples 4 to 13, further including an XOR operator to execute an initial XOR operation for an initial phase of a multi-phase stage of a sorting network between an execution element ID of each of the execution elements and a number of the multi-phase stage, wherein each output of the XOR operation is to identify an exchange partner for each of the execution elements in the initial phase and a value selector to select a greater value of each exchange partner in the initial phase for the exchange.

Example 15 may include the sorter of any one of Examples 4 to 14, further including an XOR operator to execute a subsequent XOR operation for each subsequent phase of a multi-phase stage of a sorting network between an execution element ID of each of the execution elements and a number beginning with one that doubles with each subsequent phase of the multi-phase stage, wherein each output of the subsequent XOR operation is to identify an exchange partner for each of the execution elements in the subsequent phase, an AND operator to execute an AND operation for each of the execution elements between each output of the subsequent XOR operation and the number beginning with one that doubles, wherein each output of the AND operation is to identify one or more of a value and a channel to be involved in the exchange in the subsequent phase, and a value selector to select a greater value when an output of the AND operation is to be zero and select a lesser value when the output of the AND operation is to be one.

Example 16 may include the sorter of any one of Examples 4 to 15, further including a data storer to store the values in the final output of the sorter to memory in a globally sorted order.

Example 17 may include the sorter of any one of Examples 4 to 16, further including a local ID establisher to determine a local ID for each execution element ID of each of the execution elements and a mirrored ID establisher to determine a mirrored ID for each local ID, wherein the data storer is to store the values in the final output based on each mirrored ID.

Example 18 may include the sorter of any one of Examples 4 to 17, wherein the local ID establisher is to determine a binary pattern for each execution element ID to determine each local ID, and wherein the mirrored ID establisher is to determine a mirrored binary pattern for each local ID to determine each mirrored ID.

Example 19 may include the sorter of any one of Examples 4 to 18, wherein the data storer is to scatter the values in the final output to a corresponding location in the memory based on each mirrored ID.

Example 20 may include a method to sort a value comprising exchanging a value that is held by a first execution element of a plurality of execution elements with a value that is held by a second execution element of the plurality of execution elements and comparing a value that is held by the first execution element with the value from the second execution element and a value that is held by the second execution element with the value from the first execution element, wherein the values involved in the exchange and the compare remain locally sorted and globally shuffled in a final output that is to be stored.

Example 21 may include the method of Example 20, further including implementing via a hardware execution unit an execution block including the plurality of execution elements, wherein the exchanging occurs in a phase of a sorting network, and wherein the comparing occurs in the same phase of the sorting network after the exchange.

Example 22 may include the method of any one of Examples 20 to 21, wherein the hardware execution unit includes an n-wide single instruction multiple data (SIMD) architecture, and wherein each of the execution elements utilize a single lane of the SIMD architecture.

Example 23 may include the method of any one of Examples 20 to 22, wherein the plurality of execution elements includes one or more of a plurality of work-items and a plurality of threads.

Example 24 may include the method of any one of Examples 20 to 23, further including sorting the values involved in the exchanging and the comparing based on a pattern of a bitonic sorting network.

Example 25 may include the method of any one of Examples 20 to 24, further including assigning a pair of vectors each including a set of values to each of the execution elements, wherein the pair of vectors are involved in the exchange and the compare.

Example 26 may include the method of any one of Examples 20 to 25, further including merging two vectors that each include a set of values corresponding at each of the execution elements to sort the set of values of each of the vectors into a locally sorted order.

Example 27 may include the method of any one of Examples 20 to 26, further including directly exchanging the value from the first execution element with the value from second execution element without an access to memory.

Example 28 may include the method of any one of Examples 20 to 27, further including one or more of executing an XOR operation for each of the execution elements based on an execution element identifier (ID) of each of the execution elements and executing an AND operation for each of the execution elements based on the execution element ID of each of the execution elements.

Example 29 may include the method of any one of Examples 20 to 28, further including executing the XOR operation for each of the execution elements between the execution element identifier ID of each of the execution elements and a number of a stage in a sorting network.

Example 30 may include the method of any one of Examples 20 to 29, further including executing an initial XOR operation for an initial phase of a multi-phase stage of a sorting network between an execution element ID of each of the execution elements and a number of the multi-phase stage, wherein each output of the XOR operation identifies an exchange partner for each of the execution elements in the initial phase and selecting a greater value of each exchange partner in the initial phase for the exchange.

Example 31 may include the method of any one of Examples 20 to 30, further including executing a subsequent XOR operation for each subsequent phase of a multi-phase stage of a sorting network between an execution element ID of each of the execution elements and a number beginning with one that doubles with each subsequent phase of the multi-phase stage, wherein each output of the subsequent XOR operation identifies an exchange partner for each of the execution elements in the subsequent phase, executing an AND operation for each of the execution elements between each output of the subsequent XOR operation and the number beginning with one that doubles, wherein each output of the AND operation identifies one or more of a value and a channel involved in the exchange in the subsequent phase, selecting a greater value when an output of the AND operation is zero, and selecting a lesser value when the output of the AND operation is one.

Example 32 may include the method of any one of Examples 20 to 31, further including storing the values in the final output to memory in a globally sorted order.

Example 33 may include the method of any one of Examples 20 to 32, further including determining a local ID for each execution element ID of each of the execution elements, determining a mirrored ID for each local ID, and storing the values in the final output based on each mirrored ID.

Example 34 may include the method of any one of Examples 20 to 33, further including determining a binary pattern for each execution element ID to determine each local ID and determining a mirrored binary pattern for each local ID to determine each mirrored ID.

Example 35 may include the method of any one of Examples 20 to 34, further including scattering the values in the final output to a corresponding location in the memory based on each mirrored ID.

Example 36 may include at least one computer readable storage medium comprising one or more instructions that when executed on a computing device cause the computing device to exchange a value that is to be held by a first execution element of a plurality of execution elements with a value that is to be held by a second execution element of the plurality of execution elements and compare a value that is to be held by the first execution element with the value from the second execution element and a value that is to be held by the second execution element with the value from the first execution element, wherein the values involved in the exchange and the compare are to remain locally sorted and globally shuffled in a final output that is to be stored.

Example 37 may include the at least one computer readable storage medium of Example 36, wherein when executed the one or more instructions cause the computing device to implement via a hardware execution unit an execution block including the plurality of execution elements, wherein the exchange is to occur in a phase of a sorting network, and wherein the compare is to occur in the same phase of the sorting network after the exchange.

Example 38 may include the at least one computer readable storage medium of any one of Examples 36 to 37, wherein the hardware execution unit is to include an n-wide single instruction multiple data (SIMD) architecture, and wherein each of the execution elements are to utilize a single lane of the SIMD architecture.

Example 39 may include the at least one computer readable storage medium of any one of Examples 36 to 38, wherein the plurality of execution elements is to include one or more of a plurality of work-items and a plurality of threads.

Example 40 may include the at least one computer readable storage medium of any one of Examples 36 to 39, wherein when executed the one or more instructions cause the computing device to sort the values involved in the exchange and the compare based on a pattern of a bitonic sorting network.

Example 41 may include the at least one computer readable storage medium of any one of Examples 36 to 40, wherein when executed the one or more instructions cause the computing device to assign a pair of vectors each including a set of values to each of the execution elements, wherein the pair of vectors are to be involved in the exchange and the compare.

Example 42 may include the at least one computer readable storage medium of any one of Examples 36 to 41, wherein when executed the one or more instructions cause the computing device to merge two vectors that are each to include a set of values at each of the execution elements to sort the set of values of each of the vectors into a locally sorted order.

Example 43 may include the at least one computer readable storage medium of any one of Examples 36 to 42, wherein when executed the one or more instructions cause the computing device to directly exchange the value from the first execution element with the value from second execution element without an access to memory.

Example 44 may include the at least one computer readable storage medium of any one of Examples 36 to 43, wherein when executed the one or more instructions cause the computing device to one or more of execute an XOR operation for each of the execution elements based on an execution element identifier (ID) of each of the execution elements and execute an AND operation for each of the execution elements based on the execution element ID of each of the execution elements.

Example 45 may include the at least one computer readable storage medium of any one of Examples 36 to 44, wherein when executed the one or more instructions cause the computing device to execute the XOR operation for each of the execution elements between the execution element identifier ID of each of the execution elements and a number of a stage in a sorting network.

Example 46 may include the at least one computer readable storage medium of any one of Examples 36 to 45, wherein when executed the one or more instructions cause the computing device to execute an initial XOR operation for an initial phase of a multi-phase stage of a sorting network between an execution element ID of each of the execution elements and a number of the multi-phase stage, wherein each output of the XOR operation is to identify an exchange partner for each of the execution elements in the initial phase and select a greater value of each exchange partner in the initial phase for the exchange.

Example 47 may include the at least one computer readable storage medium of any one of Examples 36 to 46, wherein when executed the one or more instructions cause the computing device to execute a subsequent XOR operation for each subsequent phase of a multi-phase stage of a sorting network between an execution element ID of each of the execution elements and a number beginning with one that doubles with each subsequent phase of the multi-phase stage, wherein each output of the subsequent XOR operation is to identify an exchange partner for each of the execution elements in the subsequent phase, execute an AND operation for each of the execution elements between each output of the subsequent XOR operation and the number beginning with one that doubles, wherein each output of the AND operation is to identify one or more of a value and a channel involved in the exchange in the subsequent phase, select a greater value when an output of the AND operation is to be zero, and select a lesser value when the output of the AND operation is to be one.

Example 48 may include the at least one computer readable storage medium of any one of Examples 36 to 47, wherein when executed the one or more instructions cause the computing device to store the values in the final output of the sorter to memory in a globally sorted order.

Example 49 may include the at least one computer readable storage medium of any one of Examples 36 to 48, determine a local ID for each execution element ID of each of the execution elements, determine a mirrored ID for each local ID, and store the values in the final output based on each mirrored ID.

Example 50 may include the at least one computer readable storage medium of any one of Examples 36 to 49, wherein when executed the one or more instructions cause the computing device to determine a binary pattern for each execution element ID to determine each local ID and determine a mirrored binary pattern for each local ID to determine each mirrored ID.

Example 51 may include the at least one computer readable storage medium of any one of Examples 36 to 50, wherein when executed the one or more instructions cause the computing device to scatter the values in the final output to a corresponding location in the memory based on each mirrored ID.

Example 52 may include an apparatus to sort a value comprising means for exchanging a value that is to be held by a first execution element of a plurality of execution elements with a value that is to be held by a second execution element of the plurality of execution elements and means for comparing a value that is to be held by the first execution element with the value from the second execution element and a value that is to be held by the second execution element with the value from the first execution element, wherein the values involved in the exchange and the compare are to remain locally sorted and globally shuffled in a final output of the sorter that is to be stored.

Example 53 may include the apparatus of Example 52, further including means for implementing via a hardware execution unit an execution block including the plurality of execution elements, wherein the exchange is to occur in a phase of a sorting network, and wherein the compare is to occur in the same phase of the sorting network after the exchange.

Example 54 may include the apparatus of any one of Examples 52 to 53, wherein the hardware execution unit is to include an n-wide single instruction multiple data (SIMD) architecture, and wherein each of the execution elements are to utilize a single lane of the SIMD architecture.

Example 55 may include the apparatus of any one of Examples 52 to 54, wherein the plurality of execution elements is to include one or more of a plurality of work-items and a plurality of threads.

Example 56 may include the apparatus of any one of Examples 52 to 55, further including means for sorting the values involved in the exchange and the compare based on a pattern of a bitonic sorting network.

Example 57 may include the apparatus of any one of Examples 52 to 56, further including means for assigning a pair of vectors each including a set of values to each of the execution elements, wherein the pair of vectors are to be involved in the exchange and the compare.

Example 58 may include the apparatus of any one of Examples 52 to 57, further including means for merging two vectors that are each to include a set of values at each of the execution elements to sort the set of values of each of the vectors into a locally sorted order.

Example 59 may include the apparatus of any one of Examples 52 to 58, further including means for directly exchanging the value from the first execution element with the value from second execution element without an access to memory.

Example 60 may include the apparatus of any one of Examples 52 to 59, further including one or more of means for executing an XOR operation for each of the execution elements based on an execution element identifier (ID) of each of the execution elements and means for executing an AND operation for each of the execution elements based on the execution element ID of each of the execution elements.

Example 61 may include the apparatus of any one of Examples 52 to 60, further including means for executing the XOR operation for each of the execution elements between the execution element identifier ID of each of the execution elements and a number of a stage in a sorting network.

Example 62 may include the apparatus of any one of Examples 52 to 61, further including means for executing an initial XOR operation for an initial phase of a multi-phase stage of a sorting network between an execution element ID of each of the execution elements and a number of the multi-phase stage, wherein each output of the XOR operation is to identify an exchange partner for each of the execution elements in the initial phase and means for selecting a greater value of each exchange partner in the initial phase for the exchange.

Example 63 may include the apparatus of any one of Examples 52 to 62, further including means for executing a subsequent XOR operation for each subsequent phase of a multi-phase stage of a sorting network between an execution element ID of each of the execution elements and a number beginning with one that doubles with each subsequent phase of the multi-phase stage, wherein each output of the subsequent XOR operation is to identify an exchange partner for each of the execution elements in the subsequent phase, means for executing an AND operation for each of the execution elements between each output of the subsequent XOR operation and the number beginning with one that doubles, wherein each output of the AND operation is to identify one or more of a value and a channel to be involved in the exchange in the subsequent phase, means for selecting a greater value when an output of the AND operation is to be zero, and means for selecting a lesser value when the output of the AND operation is to be one.

Example 64 may include the apparatus of any one of Examples 52 to 63, further including means for storing the values in the final output of the sorter to memory in a globally sorted order.

Example 65 may include the apparatus of any one of Examples 52 to 64, further including means for determining a local ID for each execution element ID of each of the execution elements, means for determining a mirrored ID for each local ID, and means for storing the values in the final output based on each mirrored ID.

Example 66 may include the apparatus of any one of Examples 52 to 65, further including means for determining a binary pattern for each execution element ID to determine each local ID and means for determining a mirrored binary pattern for each local ID to determine each mirrored ID.

Example 67 may include the apparatus of any one of Examples 52 to 66, further including further including means for scattering the values in the final output to a corresponding location in the memory based on each mirrored ID.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” or “at least one of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A computing system comprising:
a hardware execution unit to implement an execution block including a plurality of execution elements; and
a sorter including:
a data exchanger to exchange a value that is to be held by a first execution element of a plurality of execution elements with a value that is to be held by a second execution element of the plurality of execution elements; and
a data comparator to compare a value that is to be held by the first execution element with the value from the second execution element and a value that is to be held by the second execution element with the value from the first execution element, wherein the values involved in the exchange and the compare are to remain locally sorted and globally shuffled in a final output of the sorter that is to be stored.

2. The computing system of claim 1, wherein the sorter is to include one or more of:
an XOR operator to execute an XOR operation for each of the execution elements based on an execution element identifier (ID) of each of the execution elements; and
an AND operation to execute an AND operation for each of the execution elements based on the execution element ID of each of the execution elements.

3. The computing system of claim 1, further including a data storer to store the values in the final output of the sorter to memory in a globally sorted order.

4. A sorter comprising:
a data exchanger to exchange a value that is to be held by a first execution element of a plurality of execution elements with a value that is to be held by a second execution element of the plurality of execution elements; and
a data comparator to compare a value that is to be held by the first execution element with the value from the second execution element and a value that is to be held by the second execution element with the value from the first execution element, wherein the values involved in the exchange and the compare are to remain locally sorted and globally shuffled in a final output of the sorter that is to be stored.

5. The sorter of claim 4, wherein a hardware execution unit is to implement an execution block including the plurality of execution elements, wherein the exchange is to occur in a phase of a sorting network, and wherein the compare is to occur in the same phase of the sorting network after the exchange.

6. The sorter of claim 4, further including a data assigner to assign a pair of vectors each including a set of values to each of the execution elements, wherein the pair of vectors are to be involved in the exchange and the compare.

7. The sorter of claim 4, further including a combiner to merge two vectors that are each to include a set of values at each of the execution elements to sort the set of values of each of the vectors into a locally sorted order.

8. The sorter of claim 4, further including a shuffler to directly exchange the value from the first execution element with the value from second execution element without an access to memory.

9. The sorter of claim 4, further including one or more of:
an XOR operator to execute an XOR operation for each of the execution elements based on an execution element identifier (ID) of each of the execution elements; and
an AND operator to execute an AND operation for each of the execution elements based on the execution element ID of each of the execution elements.

10. The sorter of claim 9, wherein the XOR operator is to execute the XOR operation for each of the execution elements between the execution element identifier ID of each of the execution elements and a number of a stage in a sorting network.

11. The sorter of claim 4, further including:
an XOR operator to execute an initial XOR operation for an initial phase of a multi-phase stage of a sorting network between an execution element ID of each of the execution elements and a number of the multi-phase stage, wherein each output of the XOR operation is to identify an exchange partner for each of the execution elements in the initial phase; and
a value selector to select a greater value of each exchange partner in the initial phase for the exchange.

12. The sorter of claim 4, further including:
an XOR operator to execute a subsequent XOR operation for each subsequent phase of a multi-phase stage of a sorting network between an execution element ID of each of the execution elements and a number beginning with one that doubles with each subsequent phase of the multi-phase stage, wherein each output of the subsequent XOR operation is to identify an exchange partner for each of the execution elements in the subsequent phase;
an AND operator to execute an AND operation for each of the execution elements between each output of the subsequent XOR operation and the number beginning with one that doubles, wherein each output of the AND operation is to identify one or more of a value and a channel to be involved in the exchange in the subsequent phase; and
a value selector to:
select a greater value when an output of the AND operation is to be zero; and
select a lesser value when the output of the AND operation is to be one.

13. The sorter of claim 4, further including a data storer to store the values in the final output of the sorter to memory in a globally sorted order.

14. The sorter of claim 13, further including:
a local ID establisher to determine a local ID for each execution element ID of each of the execution elements; and
a mirrored ID establisher to determine a mirrored ID for each local ID, wherein the data storer is to store the values in the final output based on each mirrored ID.

15. The sorter of claim 14, wherein the local ID establisher is to determine a binary pattern for each execution element ID to determine each local ID, and wherein the mirrored ID establisher is to determine a mirrored binary pattern for each local ID to determine each mirrored ID.

16. The sorter of claim 14, wherein the data storer is to scatter the values in the final output to a corresponding location in the memory based on each mirrored ID.

17. A method comprising:
exchanging a value that is held by a first execution element of a plurality of execution elements with a value that is held by a second execution element of the plurality of execution elements; and
comparing a value that is held by the first execution element with the value from the second execution element and a value that is held by the second execution element with the value from the first execution element, wherein the values involved in the exchange and the compare remain locally sorted and globally shuffled in a final output that is to be stored.

18. The method of claim 17, further including:
assigning a pair of vectors each including a set of values to each of the execution elements, wherein the pair of vectors are involved in the exchange and the compare;
directly exchanging the value from the first execution element with the value from second execution element without an access to memory; and
merging two vectors that each include a set of values corresponding at each of the execution elements to sort the set of values of each of the vectors into a locally sorted order.

19. The method of claim 17, further including one or more of:
executing an XOR operation for each of the execution elements based on an execution element identifier (ID) of each of the execution elements; and
executing an AND operation for each of the execution elements based on the execution element ID of each of the execution elements.

20. The method of claim 17, further including storing the values in the final output to memory in a globally sorted order.

21. At least one computer readable storage medium comprising one or more instructions that when executed on a computing device cause the computing device to:
exchange a value that is to be held by a first execution element of a plurality of execution elements with a value that is to be held by a second execution element of the plurality of execution elements; and
compare a value that is to be held by the first execution element with the value from the second execution element and a value that is to be held by the second execution element with the value from the first execution element, wherein the values involved in the exchange and the compare are to remain locally sorted and globally shuffled in a final output that is to be stored.

22. The at least one medium of claim 21, wherein when executed the one or more instructions cause the computing device to:
assign a pair of vectors each including a set of values to each of the execution elements, wherein the pair of vectors are to be involved in the exchange and the compare;
directly exchange the value from the first execution element with the value from second execution element without an access to memory; and
merge two vectors that are each to include a set of values at each of the execution elements to sort the set of values of each of the vectors into a locally sorted order.

23. The at least one medium of claim 21, wherein when executed the one or more instructions cause the computing device to one or more of:
execute an XOR operation for each of the execution elements based on an execution element identifier (ID) of each of the execution elements; and
execute an AND operation for each of the execution elements based on the execution element ID of each of the execution elements.

24. The at least one medium of claim 21, wherein when executed the one or more instructions cause the computing device to store the values in the final output of the sorter to memory in a globally sorted order.
